(19) United States
(12) Patent Application Publication
(10) Pub. No.: US 2023/0319585 A1
(43) Pub. Date: Oct. 5, 2023

(54) METHODS AND SYSTEMS FOR ARTIFICIAL INTELLIGENCE BASED ARCHITECTURE IN WIRELESS NETWORK

(71) Applicant: HUAWEI TECHNOLOGIES CO., LTD., Shenzhen (CN)

(72) Inventors: Liqing ZHANG, Kanata (CA); Wen TONG, Kanata (CA); Jianglei MA, Kanata (CA); Peiying ZHU, Kanata (CA)

(21) Appl. No.: 18/330,286

(22) Filed: Jun. 6, 2023

Related U.S. Application Data
(63) Continuation of application No. PCT/CN2020/138861, filed on Dec. 24, 2020.

(51) Int. Cl. H04W 16/18; G06N 20/00

(52) U.S. Cl. CPC H04W 16/18; G06N 20/00

(57) ABSTRACT

Methods and systems for artificial intelligence (AI)-based communications are disclosed. At a second node, a task request is transmitted to a first node, the task request requiring configuration of at least one of a wireless communication functionality or a local AI model at the second node. A first set of configuration information is received from the first node, including a set of model parameters for the local AI model. The local AI model is configured by the set of model parameters to generate inference data including at least one inferred control parameter for configuring the second node for wireless communication.

### CROSS-REFERENCE TO RELATED APPLICATIONS

The present disclosure is a continuation application of International Application No. PCT/CN2020/138861, entitled “METHOD AND SYSTEMS FOR ARTIFICIAL INTELLIGENCE BASED ARCHITECTURE IN WIRELESS NETWORK”, filed Dec. 24, 2020, the entirety of which is hereby incorporated by reference.

### FIELD

The present disclosure relates to artificial intelligence based wireless communications. In particular, the present disclosure relates to a network architecture facilitating artificial intelligence based wireless communications.

### BACKGROUND

Artificial intelligence (AI), and in particular deep machine learning, is a wide-ranging branch of computer science concerned with building smart machines capable of performing tasks that typically require human intelligence. It is expected that the introduction of AI will create a paradigm shift in virtually every sector of the tech industry and AI is expected to play a role in advancement of network technologies. For example, existing communication techniques, which rely on classical analytical modeling of channels, have enabled wireless communications to take place at close to the theoretical Shannon limit. To further maximize efficient use of the signal space, existing techniques may be unsatisfactory. AI is expected to help address this challenge. Other aspects of wireless communication may benefit from the use of AI, particularly in future generations of wireless technologies, such as technologies in advanced 5G and future 6G systems, and beyond.

To support the use of AI in a wireless network, an appropriate network architecture is needed. Accordingly, it would be useful to provide a network architecture that supports the use of AI in wireless communications, including for current and future generations of wireless systems.

### SUMMARY

In various examples, the present disclosure describes network architectures that support communication of information related to AI models (e.g., configuration information defining parameters and weights of a neural network, input data and output data of a neural network, etc.). In particular, the present disclosure describes AI modules (including an AI management module, and an AI execution module) that may be implemented in a network node (which is an example of a first node at which an AI management module may be implemented) and in a system node or user equipment (which are examples of a second node at which AI execution modules may be implemented). The network node may be outside of the core network (e.g., in a separate management server, in an edge computing platform, in a RAN and/or in a UE), co-located with the core network, or within the core network, for example. The disclosed AI modules perform operations that support AI-based wireless communication, and also support development and update of AI models by a third-party (e.g., a network external of the core network).

In various examples, the present disclosure describes a task-driven approach to defining AI models, and a task-driven approach to AI-based control of wireless communication. For example, AI models defined by one or more associated tasks. An AI model may also be defined by its input-related attributes (e.g., the attributes defining the input data accepted by the model) and its output-related attributes (e.g., the attributes defining the inference data outputted by the model).

In various examples, the present disclosure describes an AI-related logical layer for communication of information related to AI models, which is added to the existing protocol stack as defined in 5G. The AI-related logical layer may provide an encrypted layer for communication of AI-related data, separate from other communications. The present disclosure also describes signaling procedures for communication of AI-related information. In particular, the disclosed examples may facilitate secure communication of AI-related information between entities in the wireless network.

In various examples, the present disclosure describes a multi-level (or hierarchical) architecture for AI-based wireless communications. An AI management module at a higher level first node (e.g., network node) provides global or centralized functions to configure an AI execution module in each lower level second node (e.g., system node or user equipment). The AI management module is able to provide global configuration of the lower level second nodes, and the AI execution module at each respective second node is able to further configure the respective second node in accordance with the local, dynamic network environment.

Examples of the present disclosure may enable more efficient and/or secure implementation of AI-based wireless communications, for example in current or future generation of wireless technologies (e.g., advanced 5G, 6G, or later generations of wireless systems).

In some example aspects, the present disclosure describes a system for wireless communications. The system includes a communication interface configured for communications with a first node; a processing unit coupled to the communication interface; and a memory storing instructions executable by the processing unit. The instructions, when executed by the processing unit, cause the system to: transmit, to the first node, a task request, the task request requiring configuration of at least one of a wireless communication functionality of the system or a local artificial intelligence (AI) model stored in the memory; and receive, from the first node, a first set of configuration information including a set of model parameters for the local AI model stored in the memory, the local AI model being configured by the set of model parameters to generate inference data including at least one inferred control parameter for configuring the system for wireless communication.

In any of the above examples, the instructions may cause the system to: execute the local AI model using the set of model parameters, to generate the at least one inferred control parameter; and configure at least one wireless communication functionality of the system in accordance with the at least one inferred control parameter.

In any of the above examples, the instructions may cause the system to: collect local data, including at least one of: local network data useable for training the local AI model; or locally trained model parameters of the local AI model; and transmit, to the first node, the collected local data.

In any of the above examples, the instructions may cause the system to: perform near-real-time training of the local AI model using the local network data to obtain an updated local AI model; and execute the updated local AI model, to generate at least one updated control parameter to configure the system.

In any of the above examples, communications with the first node may be received and transmitted over an AI-related logical layer in a protocol stack implemented by the system.

In any of the above examples, the AI-related logical layer may be a higher layer in the protocol stack above a radio resource control (RRC) layer, the AI-related logical layer being part of an AI-related control plane.

In any of the above examples, the AI-related logical layer may be a highest layer in the protocol stack above a non-access stratum (NAS) layer.

In any of the above examples, the system may be a second node that is a node in an access network serving a user equipment (UE), and the instructions may cause the system to: transmit, to the UE, a second set of configuration information including at least the at least one inferred control parameter.

In any of the above examples, the second set of configuration information further may configure the UE to collect network data local to the UE, and the instructions may cause the system to: receive, from the UE, collected network data local to the UE.

In any of the above examples, the set of model parameters in the first set of configuration information may include model parameters from a global AI model at the first node.

In any of the above examples, the system may be a second node that is a node in an access network in a wireless communication system, and the first node may be a node of a core network or another network of the wireless communication system.

In any of the above examples, the communication interface may be configured for wireless communications with the first node.

In any of the above examples, the task request may be a request for collaborative training of the local AI model.

In some example aspects, the present disclosure describes a system for wireless communications. The system includes a communication interface configured for communications with a second node; a processing unit coupled to the communication interface; and a memory storing instructions executable by the processing unit. The instructions, when executed by the processing unit, cause the system to: receive a task request requiring configuration of at least one of a wireless communication functionality or a local artificial intelligence (AI) model of the second node; and transmit, to the second node, a first set of configuration information including a set of model parameters for configuring the local AI model at the second node to generate at least one inferred control parameter for the second node, the set of model parameters being based on a configuration of at least one selected global AI model at the system, the at least one selected global AI model being selected, from a plurality of global AI models stored in the memory, in accordance with the task request.

In any of the above examples, the instructions may cause the system to: execute the at least one selected global AI model, to generate at least one globally inferred control parameter for configuring the second node; and the first set of configuration information may include the at least one globally inferred control parameter.

In any of the above examples, the instructions may cause the system to: receive, from the second node, data collected locally by the second node including at least one of: local network data useable for training the global AI model; or locally trained model parameters of the local AI model; perform training of the at least one selected global AI model using the received data to obtain at least one updated global AI model; and transmit, to the second node, updated configuration information based on a configuration of the at least one updated global AI model.

In any of the above examples, the received data may be received from a plurality of second nodes managed by the system.

In any of the above examples, communications with the second node may be received and transmitted over an AI-related logical layer in a protocol stack implemented by the system.

In any of the above examples, the AI-related logical layer may be a higher layer in the protocol stack above a radio resource control (RRC) layer, the AI-related logical layer being part of an AI-related control plane.

In any of the above examples, the AI-related logical layer may be a highest layer in the protocol stack above a non-access stratum (NAS) layer.

In any of the above examples, the set of model parameters in the first set of configuration information may include an identifier of the local AI model to be used at the second node.

In any of the above examples, the system may be a first node that is a node of a core network or another network of a wireless communication system, and the second node may be a node in an access network in the wireless communication system.

In any of the above examples, the at least one selected global AI model may be selected based on an associated task defined for the at least one selected global AI model.

In any of the above examples, the communication interface may be configured for wireless communications with the second node.

In any of the above examples, the task request may be a request for collaborative training of the local AI model.

In some example aspects, the present disclosure describes a method, at a second node configured for communications with a first node, the method including: transmitting, to the first node, a task request, the task request requiring configuration of at least one of a wireless functionality of the second node or a local artificial intelligence (AI) model stored in a memory of the second node; and receiving, from the first node, a first set of configuration information including a set of model parameters for the local AI model stored in the memory, the local AI model being configured by the set of model parameters to generate inference data including at least one inferred control parameter for configuring the second node for wireless communication.

In some example aspects, the present disclosure describes a method, at a first node configured for communications with a second node, the method including: receiving a task request requiring configuration of at least one wireless communication functionality or a local artificial intelligence (AI) model of the second node; and transmitting, to the second node, a first set of configuration information including a set of model parameters for configuring the local AI model at the second node to generate at least one inferred control parameter for the second node, the set of model parameters being based on a configuration of at least one selected global AI model at the first node, the at least one selected global AI model being selected, from a plurality of global AI models stored in a memory of the first node, in accordance with the task request.

In some example aspects, the present disclosure describes a computer readable medium having instructions stored thereon, wherein the instructions, when executed by a processing unit of a system, cause the system to perform any of the above methods.

### BRIEF DESCRIPTION OF THE DRAWINGS

Reference will now be made, by way of example, to the accompanying drawings which show example embodiments of the present application, and in which:

FIGS. 1A-1C are a simplified block diagrams illustrating some network architectures for supporting AI-based wireless communications, in accordance with examples of the present disclosure;

FIG. 2 is a simplified block diagram of an example computing system that may be used to implement examples of the present disclosure;

FIGS. 3A-3C illustrate examples of signaling over logical layers of a protocol stack, in accordance with examples of the present disclosure;

FIGS. 4A-4D illustrate examples of signaling between network entities over a logical layer, in accordance with examples of the present disclosure;

FIG. 5A is a block diagram illustrating an example dataflow in accordance with examples of the present disclosure;

FIGS. 5B and 5C are flowcharts illustrating example methods for AI-based configuration, in accordance with examples of the present disclosure; and

FIGS. 6A-6C are signaling diagrams illustrating examples of signaling that may be used for AI-based configuration and task delivery, in accordance with examples of the present disclosure.

Similar reference numerals may have been used in different figures to denote similar components.

### DESCRIPTION OF EXAMPLE EMBODIMENTS

The present disclosure describes examples that may enable the support of artificial intelligence (AI) capabilities in wireless communications. The disclosed examples may enable the use of trained AI models to generate inference data, for more efficient use of network resources and/or faster wireless communications in the AI-enabled wireless network, for example.

In the present disclosure, the term AI is intended to encompass all forms of machine learning, including supervised and unsupervised machine learning, deep machine learning, and network intelligent that may enable complicated problem solving through cooperation among AI-capable nodes. The term AI is intended to encompass all computer algorithms that can be automatically (i.e., with little or no human intervention) updated and optimized through experience (e.g., the collection of data).

In the present disclosure, the term AI model refers to a computer algorithm that is configured to accept defined input data and output defined inference data, in which parameters (e.g., weights) of the algorithm can be updated and optimized through training (e.g., using a training dataset, or using real-life collected data). An AI model may be implemented using one or more neural networks (e.g., including deep neural networks (DNN), recurrent neural networks (RNN), convolutional neural networks (CNN), and combinations thereof) and using various neural network architectures (e.g., autoencoders, generative adversarial networks, etc.). Various techniques may be used to train the AI model, in order to update and optimize its parameters. For example, backpropagation is a common technique for training a DNN, in which a loss function is calculated between the inference data generated by the DNN and some target output (e.g., ground-truth data). A gradient of the loss function is calculated with respect to the parameters of the DNN, and the calculated gradient is used (e.g., using a gradient descent algorithm) to update the parameters with the goal of minimizing the loss function.

In examples provided herein, example network architectures are described in which an AI management module that is implemented by a network node (which may be outside of or within the core network) interacts with an AI execution module that is implemented by a system node (and optionally an end user device). The present disclosure also describes a task-driven approach to defining AI models. The present disclosure also describes a logical layer and protocol for communicating AI-related data.

To assist in understanding the present disclosure, some discussion of AI models is provided below.

In the present disclosure, an AI model encompasses neural networks, which are used in machine learning. A neural network is composed of a plurality of computational units (which may also be referred to as neurons), which are arranged in one or more layers. The process of receiving an input at an input layer and generating an output at an output layer may be referred to as forward propagation. In forward propagation, each layer receives an input (which may have any suitable data format, such as vector, matrix, or multidimensional array) and performs computations to generate an output (which may have different dimensions than the input). The computations performed by a layer typically involve applying a set of weights (also referred to as coefficients) to the input (e.g., by multiplying). With the exception of the first layer of the neural network (i.e., the input layer), the input to each layer is the output of a previous layer. A neural network may include one or more layers between the first layer (i.e., input layer) and the last layer (i.e., output layer), which may be referred to as inner layers or hidden layers. Various neural networks may be designed with various architectures (e.g., various numbers of layers, with various functions being performed by each layer).

A neural network is trained to optimize the parameters (e.g., weights) of the neural network. This optimization is performed in an automated manner, and may be referred to as machine learning. Training of a neural network involves forward propagating an input data sample to generate an output value (also referred to as a predicted output value or inferred output value), and comparing the generated output value with a known or desired target value (e.g., a ground-truth value). A loss function is defined to quantitatively represent the difference between the generated output value and the target value, and the goal of training the neural network is to minimize the loss function. Backpropagation is an algorithm for training a neural network. Backpropagation is used to adjust (also referred to as update) a value of a parameter (e.g., a weight) in the neural network, so that the computed loss function becomes smaller. Backpropagation involves computing a gradient of the loss function with respect to the parameters to be optimized, and a gradient algorithm (e.g., gradient descent) is used to update the parameters to reduce the loss function. Backpropagation is performed iteratively, so that the loss function is converged or minimized over a number of iterations. After a training condition is satisfied (e.g., the loss function has converged, or a predefined number of training iterations have been performed), the neural network is considered to be trained. The trained neural network may be deployed (or executed) to generate inferred output data from input data. It should be noted that training of a neural network may be ongoing even after a neural network has been deployed, such that the parameters of the neural network may be repeatedly updated with up-to-date training data.

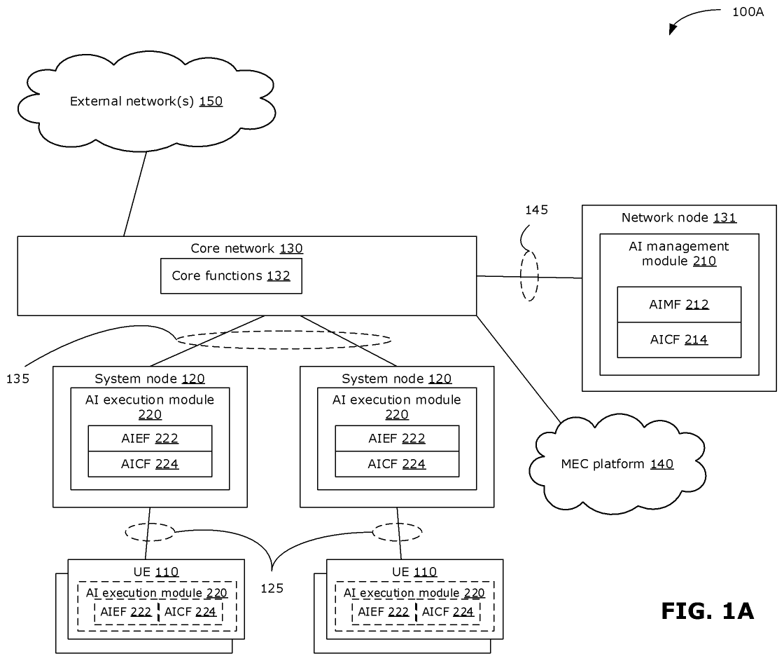

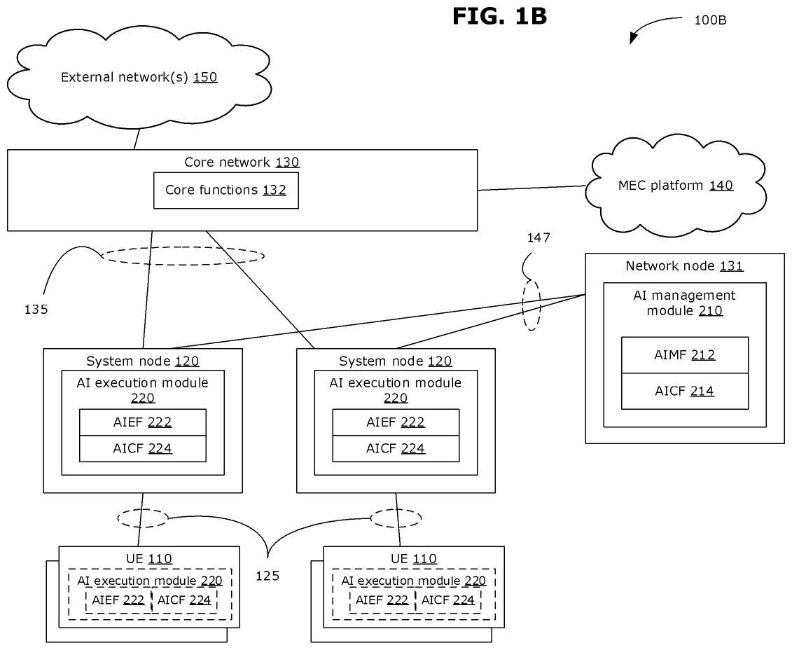

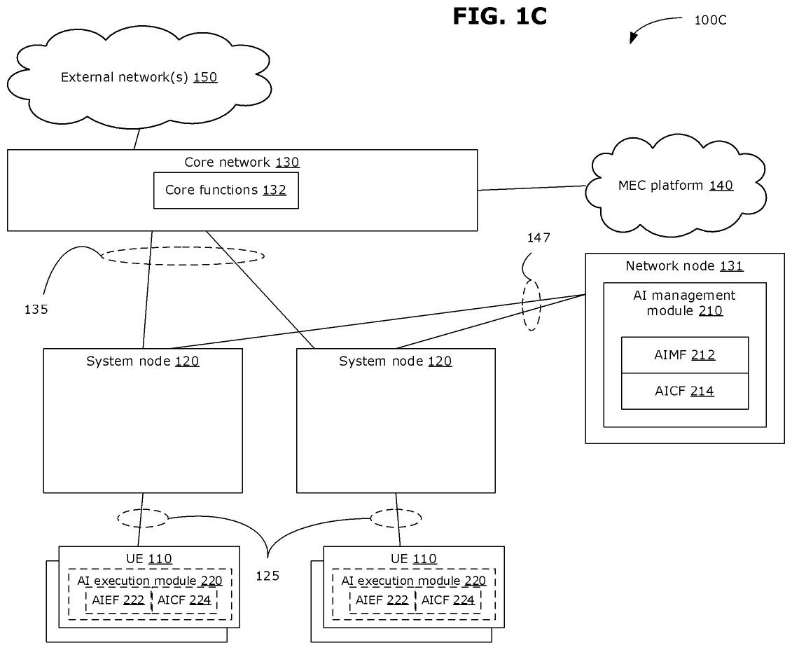

FIG. 1A illustrates a wireless system 100A implementing an example network architecture, in accordance with embodiments of the present disclosure. The wireless system 100A enables multiple wireless or wired elements to communicate data and other content. The wireless system 100A may enable content (e.g., voice, data, video, text, etc.) to be communicated (e.g., via broadcast, narrowcast, peer-to-peer, etc.) among entities of the system 100A. The wireless system 100A may operate by sharing resources such as bandwidth. The wireless system 100A may be suitable for wireless communications using 5G technology and/or later generation wireless technology (e.g., 6G or later generations). In some examples, the wireless system 100A may also accommodate some legacy wireless technology (e.g., 3G or 4G wireless technology).

In the example shown, the wireless system 100A includes a plurality of user equipment (UEs) 110, a plurality of system nodes 120, and a core network 130. The core network 130 may be connected to a multi-access edge computing (MEC) platform 140, and one or more external networks 150 (e.g., a public switched telephone network (PSTN), the internet, other private network, etc.). Although certain numbers of these components or elements are shown in FIG. 1A, any reasonable number of these components or elements may be included in the wireless system 100A.

Each UE 110 may independently be any suitable end device for wireless operation and may include such electronic devices (or may be referred to) as a wireless transmit/receive unit (WTRU), customer premises equipment (CPE), a smart device, an Internet of Things (IoT) device, a wireless-enabled vehicle, a mobile station, a fixed or mobile subscriber unit, a cellular telephone, a station (STA), a machine type communication (MTC) device, a personal digital assistant (PDA), a smartphone, a laptop, a computer, a tablet, a wireless/wireline sensor, or a consumer electronics device, among other possibilities. Future generation UEs 110 may be referred to using other terms. For example, UEs 110 may be referred to generally as electronic devices (EDs).

A system node 120 may be any node of an access network (AN) (also referred to as a radio access network (RAN)). For example, a system node 120 may be a base station (BS) of an AN. Each system node 120 is configured to wirelessly interface with one or more of the UEs 110 to enable access to the respective AN. A given UE 110 may connect with a given system node 120 to enable access to the core network 130, another system node 120, the MEC platform 140 and/or external network(s) 150. For example, the system node 120 may include (or be) one or more of several well-known devices, such as a base transceiver station (BTS), a radio base station, a Node-B (NodeB), an evolved NodeB (eNodeB), a Home eNodeB, a gNodeB (sometimes called a next-generation Node B), a transmission point (TP), a transmit and receive point (TRP), a site controller, an access point (AP), an AP with sensing functionality, a dedicated sensing node, or a wireless router, among other possibilities. A system node 120 may also be or include a mobile node, such as a drone, an unmanned aerial vehicle (UAV), a network-enabled vehicle (e.g., autonomous or semi-autonomous vehicle), etc. A system node 120 may also be or include a non-terrestrial node, such as a satellite. Future generation system nodes 120 may encompass other network-enabled nodes, and may be referred to using other terms.

The core network 130 may include one or more core servers or server clusters. The core network 130 provides core functions 132, such as core access and mobility management function (AMF), user plane function (UPF), and sensing management/control function, among others. UEs 110 may be provided with access to the core functions 132 via respective system nodes 120. The core network 130 may also serve as a gateway access between (i) the system nodes 120 or UEs 110 or both, and (ii) the external network(s) 150 and/or MEC platform 140. The core network 130 may provide a convergence interface (not shown) that is a common interface for all access types (e.g., wireless or wired access types).

The MEC platform 140 may be a distributed computing platform, in which a plurality of MEC hosts (typically edge servers) provide distributed computing resources (e.g., memory and processor resources). The MEC platform 140 may provide functions and services closer to end users (e.g., physically located closer to the system nodes 120, compared to the core network 130), which may help to reduce latency in provisioning of such functions and services.

FIG. 1A also illustrates a network node 131, which may be any node in the network-side of the wireless system 100A (i.e., any node that is not a UE 110). For example, the network node 131 may be a node of the MEC platform 140 (e.g., a MEC host), may be a node of an external network 150 (e.g., a network server), or a node within the core network 130 (e.g., a core server), among other possibilities. The network node 131 may be outside of the core network 130 but directly connected to the core network 130. The network node 131 may be a node that is connected between the core network 130 and the system nodes 120 (e.g., outside of but close to the ANs, or within one or more ANs). The network node 131 may be dedicated to supporting AI capabilities (e.g., dedicated to performing AI management functions as disclosed herein), and may be accessible by multiple entities of the wireless system 100A (including the external networks 150 and MEC platform 140, although such links are not shown in FIG. 1A for simplicity), for example. It should be noted that, although the present disclosure provides examples in which the network node 131 provides certain AI functionalities (e.g., an AI management module 210, discussed further below), the functionality of the network node 131 or similar AI functionalities (e.g., more execution-focused functionalities and fewer training-focused functionalities) may be provided by a system node 120 or a UE 110. For example, functionalities that are described as being provided at the network node 131 may additionally or alternatively be provided at a system node 120 or UE 110 as an integrated/imbedded function or dedicated AI function. Moreover, the network node 131 may have its own a sensing functionality and/or dedicated sensing node(s) (not shown) to obtain the sensed information (e.g., network data) for AI operations. In some examples, the network node 131 may be an AI-dedicated node that is capable of performing more intense and/or large amounts of computation (which may be required for comprehensive training of AI models). Further, although illustrated as a single network node 131, it should be understood that the network node 131 may in fact be a representation of a distributed computing system (i.e., the network node 131 may in fact be a group of multiple physical computing systems) and is not necessarily a single physical computing system. It should also be understood that the network node 131 may include future network nodes that may be used in future generation wireless technology.

The system nodes 120 communicate with respective one or more UEs 110 over AN-UE interfaces 125, typically air interfaces (e.g. radio frequency (RF), microwave, infrared (IR), etc.). For example, a RAN-UE interface may be a Uu link (e.g., in accordance with 5G or 4G wireless technologies). The UEs 110 may also communicate directly with one another via one or more sidelink interfaces (not shown). The system nodes 120 each communicate with the core network 130 over AN-core network (CN) interfaces 135 (e.g., NG interfaces, in accordance with 5G technologies). The network node 131 may communicate with the core network 130 over a dedicated interface 145, discussed further below. Communications between the system nodes 120 and the core network 130, between two (or more system nodes 120) and/or between the network node 131 and the core network 130 may be over a backhaul link. Communications in the direction from UEs 110 to system nodes 120 to the core network 130 may be referred to as uplink (UL) communications, and communications in the direction from the core network 130 to system nodes 120 to UEs 110 may be referred to as downlink (DL) communications.

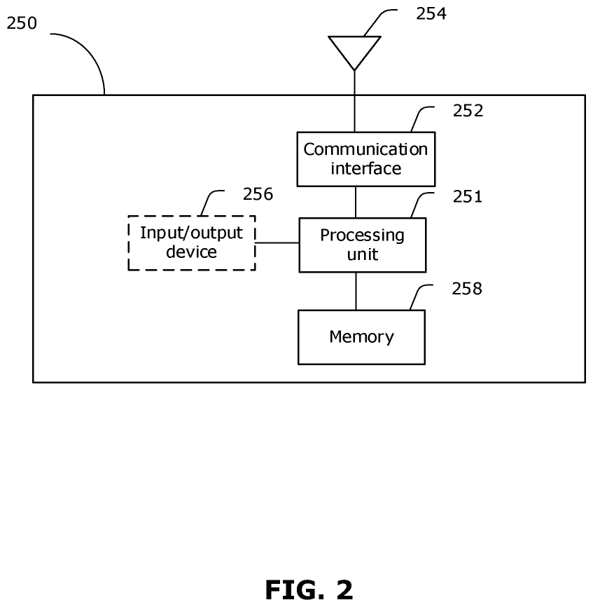

FIG. 2 illustrates an example apparatus that may implement the methods and teachings according to this disclosure. In particular, FIG. 2 illustrates an example computing system 250, which may be used to implement a UE 110, a system node 120, or a network node 131. As will be discussed further below, the computing system 250 may be specialized, or include specialized components, to support training and/or execution of AI models (e.g., training and/or execution of neural networks).

As shown in FIG. 2, the computing system 250 includes at least one processing unit 251. The processing unit 251 implements various processing operations of the computing system 250. For example, the processing unit 251 could perform signal coding, data processing, power control, input/output processing, or any other functionality of the computing system 250. In addition, the processing unit 251 may also be configured to implement computations required to train and/or execute an AI model. In some examples, the processing unit 251 may be a specialized processing unit capable of performing a large number of computations for training an AI model. The processing unit 251 may, for example, include a microprocessor, microcontroller, digital signal processor, field programmable gate array, application specific integrated circuit, neural processing unit (NPU), tensor processing unit (TPU), or a graphics processing unit (GPU). In some examples, there may be multiple processing units 251 in the computing system 250, with at least one processing unit 251 being a central processing unit (CPU) responsible for performing core functions of the computing system 250 (e.g., execution of an operating system (OS)), and at least another processing unit 251 being responsible for performing specialized functions (e.g., carrying out computations for training and/or executing an AI model).

The computing system 250 includes at least one communication interface 252 for wired and/or wireless communications. Each communication interface 252 includes any suitable structure for generating signals for wireless or wired transmission and/or processing signals received wirelessly or by wire. The computing system 250 in this example includes at least one antenna 254, for example, for a wireless communication interface 252 (in other examples, the antenna 254 may be omitted, for example, for a wireline communication interface 252). Each antenna 254 includes any suitable structure for transmitting and/or receiving wireless or wired signals. One or multiple communication interfaces 252 could be used in the computing system 250. One or multiple antennas 254 could be used in the computing system 250. In some examples, one or more antennas 254 may be an antenna array, which may be used to perform beamforming and beam steering operations. Although shown as a single functional unit, a communication interface 252 could also be implemented using at least one transmitter interface and at least one separate receiver interface. The processing unit 251 is coupled to the communication interface 252, for example to provide data to be transmitted and/or to receive data via the communication interface 252. The processing unit 251 may also control the operation of the communication interface 252 (e.g., to set parameters for wireless signaling).

The computing system 250 may include one or more optional input/output devices 256. The input/output device(s) 256 permit interaction with a user and/or optionally interaction directly with other nodes such as a UE 110, a system node 120 (e.g., a base station), a network node 131, or a functional node in the core network 130. Each input/output device 256 may include any suitable structure for providing information to or receiving information from a user, such as a speaker, microphone, keypad, keyboard, display, or touchscreen, among other possibilities. The processing unit 251 is coupled to the input/output device(s) 256, for example to provide data to be outputted via an output device or to receive data inputted via an input device.

The computing system 250 includes at least one memory 258. The memory 258 stores instructions and data used, generated and/or collected by the computing system 250. For example, the memory 258 could store software instructions or modules configured to implement some or all of the functionality and/or embodiments described herein. The processing unit 251 is coupled to the memory 258 to enable the processing unit 251 to execute instructions stored in the memory 258, and to store data into the memory 258, for example. The memory 258 may include any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, and the like.

Reference is again made to FIG. 1A. AI capabilities in the wireless system 100A are supported by functions provided by an AI management module 210, and at least one AI execution module 220. The AI management module 210 and the AI execution module 220 are software modules, which may be encoded as instructions stored in memory and executable by a processing unit.

In the example shown, the AI management module 210 is located in the network node 131, which may be co-located with or located within the MEC 140 (e.g., implemented on a MEC host, or implemented in a distributed manner over multiple MEC hosts). In other examples, the AI management module 210 may be located in the network node 131 that is a node of an external network 150 (e.g., implemented in a network server of the external network 150). In general, the AI management module 210 may be located in any suitable network node 131, and may be located in a network node 131 that is part of or outside of the core network 130. In some examples, locating the AI management module 210 in a network node 131 that is outside of the core network 130 may enable a more open interface with external network(s) 150 and/or third-party services, although this is not necessary. The AI management module 210 may manage a large number of different AI models designed for different tasks, as discussed further below. Although the AI management module 210 is shown within a single network node 131, it should be understood that the AI management module 210 may also be implemented in a distributed manner (e.g., distributed over multiple network nodes 131, or the network node 131 is itself a representation of a distributed computing system).

In this example, each system node 120 implements a respective AI execution module 220. For example, the system node 120 may be a BS within an AN, and may implement the AI execution module 220 and perform the functions of the AI execution module 220 on behalf of the entire AN (or on behalf of a portion of the AN). In another example, each BS within an AN may be a system node 120 that implements its own AI execution module 220. Thus, the multiple system nodes 120 shown in FIG. 1A may or may not belong to the same AN. In another example, the system node 120 may be a separate AI-capable node (i.e., not a BS) in the AN, which may or may not be dedicated to providing AI functionality. Although each AI execution module 220 is shown within a single system node 120, it should be understood that each AI execution module 220 may independently and optionally be implemented in a distributed manner (e.g., distributed over multiple system nodes 120, or the system node 120 itself may be a representation of a distributed computing system).

The AI execution module 220 may interact with some or all software modules of the system node 120. For example, the AI execution module 220 may interface with logical layers such as the physical (PHY) layer, media access control (MAC) layer, radio link control (RLC), packet data convergence protocol (PDCP) layer, and/or upper layers (at the system node 120, the logical layers may be functionally split into higher-level centralized unit (CU) layers and lower-level distributed unit (DU) layers) of the system node 120. For example, the AI execution module 220 may interface with control modules of the system node 120 using a common application programming interface (API).

Optionally, a UE 110 may also implement its own AI execution module 220. The AI execution module 220 implemented by a UE 110 may perform functions similar to the AI execution module 220 implemented at a system node 120. Other implementations may be possible. It should be noted that different UEs 110 may have different AI capabilities. For example, all, some, one or none of the UEs 110 in the wireless system 100A may implement a respective AI execution module 220.

In this example the network node 131 may communicate with one or more system nodes 120 via the core network 130 (e.g., using AMF or/and UPF provided by the core functions 132 of the core network 130). The network node 131 may have a communication interface with the core network 130 using the interface 145, which may be a common API interface or a specialized interface dedicated for AI-related communications (e.g., for communications using a AI-related protocol, such as the protocols disclosed herein). It should be noted that the interface 145 enables direct communication between the network node 131 and the core network 130 (regardless of whether the network node 131 is within, near, or outside of the core network 130), bypassing a convergence interface (which may be typically required in this scenario for communications between the core network 130 and all external networks 150). In another embodiment, the network node 131 is within the core network 130 and the interface 145 is an inter communication interface in the core network 130, such as the common API interface. The interface 145 may be a wired or wireless interface, and may be a backhaul link between the network node 131 and the core network 130, for example. The interface 145 may be an interface not typically found in 4G or 5G wireless systems. The core network 130 may thus serve to forward or relay AI-related communications between the AI execution modules 220 at one or more system nodes 120 (and optionally at one or more UEs 110) and the AI management module 210 at the network node 131. In this way, the AI management module 210 may be considered to provide a set of AI-related functions in parallel with the core functions 132 provided by the core network 130.

AI-related communications between the system node 120 and one or more UEs 110 may be via an existing interface such as the Uu link in 5G and 4G network systems, or may be via an AI-dedicated air interface (e.g., using an AI-related protocol on an AI-related logical layer, as discussed herein). For example, AI-related communications between a system node 120 and a UE 110 served by the system node 120 may be over an AI-dedicated air interface, whereas non-AI-related communications may be over a 5G or 4G Uu link.

FIG. 1A illustrates an example disclosed architecture in which the AI management module 210 and AI execution modules 220 may be implemented. Other example architectures are now discussed.

FIG. 1B illustrates a wireless system 100B implementing another example network architecture, in accordance with embodiments of the present disclosure. It should be appreciated that the network architecture of FIG. 1B has many similarities with that of FIG. 1A, and details of the common elements need not be repeated.

Compared to the example shown in FIG. 1A, the network architecture of the wireless system 100B of FIG. 1B enables the network node 131, at which the AI management module 210 is implemented, to interface directly with each system node 120 via an interface 147 to each system node 120 (e.g., to at least one system node 120 of each AN). The interface 147 may be a common API interface or a specialized interface dedicated for AI-related communications (e.g., for communications using an AI-related protocol, such as the protocols disclosed herein). It should be noted that the interface 147 enables direct communication between the AI management module 210 and the AI execution module 220 at each system node 120 (regardless of whether the network node 131 is a node in the MEC platform 140 or in an external network 150, or if the network node 131 is part of the core network 130). The interface 147 may be a wired or wireless interface, and may be a backhaul link between the network node 131 and the system node 120, for example. The interface 147 may not be typically found in 4G or 5G wireless systems. The network node 131 in FIG. 1B may also be accessible by the external network(s) 150, the MEC platform 140 and/or the core network 130 (although such links are not shown in FIG. 1B for simplicity).

FIG. 1C illustrates a wireless system 100C implementing another example network architecture, in accordance with embodiments of the present disclosure. It should be appreciated that the network architecture of FIG. 1C has many similarities with that of FIGS. 1A and 1B, and details of the common elements need not be repeated. FIG. 1C illustrates an example architecture in which the AI management module 210 is located in a network node 131 that is physically close to the one or more system nodes 120 of the one or more ANs being managed using the AI management module 210. For example, the network node 131 may be co-located with or within the MEC platform 140, or may be co-located with or within an AN.

Compared to the examples shown in FIGS. 1A and 1B, the network architecture of the wireless system 100C of FIG. 1C omits the AI execution module 220 from the system nodes 120. One or more local AI models (and optionally a local AI database) that would otherwise be maintained at a local memory of each system nodes 120 may be instead maintained at a memory local to the network node 131 (e.g., in a memory of a MEC host, or in a distributed memory on the MEC platform 140). Although not shown in FIG. 1C, the network node 131 may implement one or more AI execution modules 220, or may implement functionalities of the AI execution module 220, in addition to the AI management module 210, for example to enable collection of network data and near-real-time training and execution of AI models, and/or to enable separation of global and local AI models.

Because the network node 131 is located physically close to the system nodes 120, communication between each system node 120 (e.g., from one or more ANs) and the network node 131 may be carried out with very low latency (e.g., latency on the order of only a few microseconds or only a few milliseconds). Thus, communications between the system nodes 120 and the network node 131 may be carried out in near-real-time. Communication between each system node 120 and the network node 131 may be over the interface 147, as described above. The interface 147 may be an AI-dedicated communication interface, supporting low-latency communications.

Details of the AI management module 210 and the AI execution module 220 are now described. The following discussions are equally applicable to the architectures of any of the wireless systems 100A-100C (generally referred to as the wireless system 100) of FIGS. 1A-1C. It should be understood that the AI management module 210 and the AI execution module 220, as disclosed herein, are not limited by the specific architectures shown in FIGS. 1A-1C. For example, the AI management module 210 may be implemented at a system node 120 (e.g., at an AI-dedicated node in an AN) to management AI execution modules 220 implemented at other system nodes 120 and/or UEs 110. In another example, an instance of the AI execution module 220 may be implemented at a system node 120 that is an AI-capable node in an AN, separate from the BSs of the AN. In another example, an instance of the AI execution module 220 may be implemented at the network node 131 (e.g., at a network node 131 having data collection capabilities) together with the AI management module 210. In some examples, the AI management module 210 may be implemented in any node of the wireless system 100 (which may or may not be part of a network managed by the core network 130), and the node providing the functions of the AI management module 210 may be referred to as the AI management node (or simply management node). In some examples, the AI execution module 220 may be implemented in any node of the wireless system 100 (including the UE 110, system node 120, or other AI-capable node), and the node providing the functions of the AI execution module 220 may be referred to as the AI execution node (or simply execution node). Further, functions of the AI management module 210 may be implemented in any AI-capable node, which may be generally referred to as a first node (e.g., the network node 131 may be an example of the first node that provides functions of the AI management module 210, but this is not intended to be limiting); and functions of the AI execution module 220 may be implemented in any AI-capable node, which may be generally referred to as a second node (e.g., the system node 120 or the UE 110 may be an example of the second node that provides functions of the AI execution module 220, but this is not intended to be limiting).

Implementation of the AI management module 210 and the AI execution modules 220 provide multi-level (or hierarchical) AI management and control in the wireless system 100. The AI management module 210 provides global or centralized functions to manage and control one or more system nodes 120 (and one or more ANs). In turn, the AI execution module 220 in each system node 120 provides functions to manage and service one or more UEs 110. It should be understood that, in some examples, at least some functions that are described as being provided by the AI management module 210 may additionally or alternatively be provided by the AI execution module 220. Similarly, in some examples, at least some functions that are described as being provided by the AI execution module 220 may additionally or alternatively be provided by the AI management module 210. For example, as previously mentioned, functions of the AI management module 210 may be provided together with at least some execution functions of the AI execution module 220, for example in the system node 120 or UE 110 (in addition to or instead of the network node 131). In another example, data collection and/or execution functions of the AI execution module 220 may be provided together with the functions of the AI management module 210 at a network node 131 having sensing functionality (e.g., capable of collected network data). For ease of understanding, the following discussion describes certain functions at the AI management module 210 and the AI execution module 220; however, it should be understood that this is not intended to be limiting.

The AI management module 210 provides AI management functions (AIMF) 212 and AI-based control functions (AICF) 214. The AI execution module 220 provides AI execution functions 222 and AICF 224. The AICF 224 provided by the AI execution module 220 may be similar to the AICF 214 provided by the AI management module 210. It should be understood that the present disclosure describes the AI management module 210 as having functions provided by the AIMF 212 and AICF 214 for ease of understanding; however, it is not necessary for the functionality of the AI management module 210 to be logically separated into the AIMF 212 and AICF 214 as discussed below (e.g., the functions of the AIMF 212 and the AICF 214 may simply be considered functions of the AI management module 210 as a whole; or some functions provided by the AIMF 212 may instead be functions provided by the AICF 214 and vice versa). In a similar way, the AI execution module 220 is described as having functions provided by the AIEF 222 and the AICF 224 for ease of understanding, but this is not intended to be limiting (e.g., the functions of the AIEF 222 and the AICF 224 may simply be considered functions of the AI execution module 220 as a whole; or some functions provided by the AIEF 222 may instead be functions provided by the AICF 224 and vice versa). The AI management module 210 may perform functions to manage and/or interface with a plurality of AI execution modules 220. In some examples, the AI management module 210 may provide centralized (or global) management of a plurality of AI execution modules 220.

The AIMF 212 may include AI management and configuration functions, AI input processing functions, AI output processing functions, AI modeling configuration functions, AI training functions, AI execution functions and/or AI database functions. A plurality of global AI models may be stored and/or maintained (e.g., trained) by the AI management module 210 using functions of the AIMF 212. In the present disclosure a global AI model refers to an AI model that is implemented at the network node 131. The global AI model has been or is intended to be trained based on globally collected network data. the global AI model may be executed by the AI management module 210 inference output that may be used for setting global configurations (e.g., configurations that are applicable to multiple ANs, or configurations that are applicable to all AI execution modules 220 managed by the AI management module 210). The trained weights of a global AI model may also be further updated at an AI execution module 220, using locally collected network data, as discussed further below.

The AI management module 210 may use functions of the AIMF 212 to maintain a global AI database and/or to access an external AI database (not shown). The global AI database may contain data collected from all the AI execution modules 220 managed by the AI management module 210, and that may be used to train global AI models. The global AI models (and optionally the global AI database) may be stored in a memory coupled to the AI management module 210 (e.g., a memory of a server in which the AI management module 210 is implemented, or a distributed memory on a distributed computing platform in which the AI management module 210 is implemented).

AI management and configuration functions provided by the AIMF 212 may include configuring AI policy (e.g., security-related policies for collection of AI-related data, service-related policies for servicing certain customers, etc.), configuring key performance indicators (KPI) (e.g., latency, quality of service (QoS), throughput, etc.) to be achieved by the wireless system 100, and providing an interface other nodes in the wireless system 100 (e.g., interfacing with the core network 130, the MEC platform 140 and/or an external network 150). The AI management and configuration functions may also include defining an AI model (which may be a global AI model or a local AI model), including defining the task associated with each global or local AI model. In the present disclosure, the term task refers to any task that may be performed using inferred data generated by a trained AI model. A task may be a network task, which addresses a network performance and/or service to be achieved (e.g., providing high throughput). For example, performing a network task typically involves optimization of more than a single parameter. In some examples, a task may be a collaborative task that involves cooperation among multiple nodes to perform an AI-related task. For example, a collaborative task may be to train an AI model (e.g., a global AI model) to perform a task (e.g., to perform object detection and recognition) that requires collection of a large amount of training data. The AI management module 210 may manage multiple AI execution modules 220 at respective system nodes 120 to collaboratively train a global AI model (e.g., similar to federated learning methods). Another example collaborative task may be for the AI management module 210 to train an AI model on behalf of an AI execution module 220, possibly using data collected by the AI execution module 220. For example, a system node 120 or UE 110 may wish to implement a local AI model that is trained on local data, but may request that the AI management module 210 (e.g., at the network node 131) perform the training (e.g., the system node 120 or UE 110 may have limited computing power and/or memory resources that are required for training an AI model). It should be noted that, in some collaborative tasks in which the AI management module 210 participates in training an AI model, it may not be necessary for the AI management module 210 to understand the content of the data used to train the AI model or to understand the inferred data and/or optimization target of the AI model. It should be understood that other such tasks, including other network tasks and/or other tasks that require cooperation among multiple nodes, which may be managed by the AI management module 210, are within the scope of the present disclosure. As will be discussed further below, one or more AI models may be used together to generate inference data for a particular task.

Each AI model (which may be a global AI model or a local AI model) may be defined with input attributes (e.g., type and characteristics of data that can be accepted as input to the AI model) and output attributes (e.g., type and characteristics of data that is generated as inference output by the AI model), as well as one or more targeted tasks (e.g., the network problem or issue to be addressed by the inference data outputted by the AI model). The input attributes and output attributes of each AI model may be defined from a set of possible input attributes and a set of possible output attributes (respectively) that have been defined for the wireless system 100 as a whole (e.g., standardized according to a network standard). For example, a standard may specify that end-to-end latency can be used as input data to an AI model, but UE-AN latency cannot be used as input data; or a standard may specify that identification of a handover scheme may be inference output by an AI model, but a specific waveform cannot be inference output by an AI model. It may be up to developers of AI models to ensure that each AI model is designed to comply with the standardized input attributes and output attributes.

AI input processing functions provided by the AIMF 212 may include receiving input data (e.g., local data from the UEs 110 and/or the system nodes 120, which may be received via one or more AI execution modules 220), which may be used to train a global AI model. For example, the AI input processing functions may include implementing an AI-based protocol, as disclosed herein, for receiving AI-related input data from an AI execution module 220. The AI input processing functions may also include preprocessing received data (e.g., performing normalization, noise removal, etc.) to enable the data to be used for training and/or execution of a global AI model, and/or prior to storing the data in an AI database (e.g., the global AI database maintained using the AIMF 212, or an external AI database).

AI output processing functions provided by the AIMF 212 may include outputting data (e.g., inference data generated by a global AI model, configuration data for configuring a local AI model, etc.). For example, the AIMF 212 may use an AI-based protocol as disclosed herein for communicating AI-related output data. The AI output processing functions may include providing output data to enable radio resource management (RRM). For example, the AI management module 210 may use a trained global AI model to output an inferred control parameter (e.g., transmit power, beamforming parameters, data rates, etc.) for RRM. The AIMF 212 may interface with another function responsible for performing RRM, to provide such AI-generated output.

AI modeling configuration functions provided by the AIMF 212 may include configuring a global or local AI model. The AIMF 212 may be responsible for configuring global AI models of the AI management module 210, as well as providing configuration data for configuring local AI models (which are maintained by the AI execution module(s) 220 managed by the AI management module 210). Configuring a global or local AI model may include defining parameters of the AI model, such as selecting the global or local AI model to be used for performing a given task, and may also include setting the initial weights of the global or local AI model. In some examples, the AI management module 210 may be used to perform a collaborative task with one or more AI execution modules 220 for training a global or local AI model, and the global or local AI model to be trained may be selected by an AI execution module 220 instead (and an identifier of the selected AI model may be communicated to the AI management module 210). AI modeling configuration functions may also include configuring related relationships among more than one AI model (e.g., in examples of splitting one AI task or operation into sub-task roles or sub-task operations performed by multiple AI models).

AI training functions provided by the AIMF 212 may include carrying out training of a global AI model (using any suitable training algorithm, such as minimizing a loss function using backpropagation), and may include obtaining training data from a global AI database, for example. AI training functions may also include storing the results of the training (e.g., the trained parameters, such as optimized weights, of the global AI model). The parameters of a trained global AI model (e.g., the optimized weights of a global AI model) may be referred to as global model parameters.

AI execution functions provided by the AIMF 212 may include executing a trained global AI model (e.g., using the trained global model parameters), and outputting the generated inference data (using the AI output processing functions of the AIMF 212). For example, the inference data outputted as a result of execution of the trained global AI model may include one or more control parameters, for use in AI-based RRM.

AI database functions provided by the AIMF 212 may include operations for global data collection (e.g., collecting local data from UEs 110 and/or system nodes 120, which may be communicated via the AI execution module(s) 220 managed by the AI management module 210). The collected data may be stored in a global AI database, and may be used for training global AI models. Data maintained in the global AI database may include network data and may also include model data. In the present disclosure, network data may refer to data that is collected and/or generated by a node (e.g., UE 110 or system node 120, or the network node 131 in the case where the network node 131 has data collection capabilities) in normal real-life usage. Network data may include, for example, measurement data (e.g., measurements of network performance, measurements of traffic, etc.), monitored data (e.g., monitored network characteristics, monitored KPIs, etc.), device data (e.g., device location, device usage, etc.), and user data (e.g., user photographs, user videos, etc.), among others. In the present disclosure, model data may refer to data that is extracted and/or generated by an AI model (e.g., a local AI model or a global AI model). Model data may include, for example, parameters (e.g., trained weights) extracted from an AI model, configuration of an AI model (including identifier of the AI model), and inferred data generated by an AI model, among others. The data in the global AI database may be any data suitable for training an AI model. The AI database functions may also include standard database management functions, such as backup and recovery functions, archiving functions, etc.

The AIEF 222 may include AI management and configuration functions, AI input processing functions, AI output processing functions, AI training functions, AI execution functions and/or AI database functions. Some of the functions of the AIEF 222 may be similar to the functions of the AIMF 212, but performed in a more localized context (e.g., in the local context of the system node 120 (e.g., local to the AN) or in the local context of the UE 110, rather than globally (e.g., across multiple ANs)). One or more local AI models may be stored and/or maintained (e.g., trained) by the AI execution module 220 using functions of the AIEF 222. In the present disclosure, a local AI model refers to an AI model that is implemented in a system node 120 (or optionally a UE 110). The local AI model may be trained on locally collected network data. For example, a local AI model may be obtained by adapting a global model to local network data (e.g., by performing further training to update globally-trained parameters, using measurements of the current network performance). A local AI model may be configured similarly to a global AI model (e.g., using global parameters communicated from the AI management module 210 to the AI execution module 220) that is deployed by the AI execution module 220 without further training on local network data (i.e., the local AI model may use the globally trained weights of the global AI model). The AI execution module 220 may also use functions of the AIEF 222 to maintain a local AI database and/or to access an external AI database (not shown). The local AI model(s) (and optionally the local AI database) may be stored in a memory coupled to the AI execution module 220 (e.g., a memory of a BS in which the AI execution module 220 is implemented, or a memory of a UE 110 which the AI execution module 220 is implemented).

AI management and configuration functions provided by the AIEF 222 may include configuring a local AI model (e.g., in accordance with AI model configuration information provided by the AI management module 210), configuring KPIs (e.g., in accordance with KPI configuration information provided by the AI management module 210) to be achieved locally (e.g., at the system node 120 or the UE 110), and updating a local AI model (e.g., updating parameters of the local AI model, based on updated global model parameters communicated by the AI management module 210 and/or based on local training of the local AI model).

AI input processing functions provided by the AIEF 222 may include receiving input data (e.g., network data and/or model data collected from UE(s) 110 serviced by the system node 120 in which the AI execution module 220 is implemented, network data collected by the UE 110 in which the AI execution module 220 is implemented, or network data collected by the system node 120 in which the AI execution module 220 is implemented), which may be used to train a local AI model. AI input processing functions may also include preprocessing received data (e.g., performing normalization, noise removal, etc.) to enable the collected data to be used for training and/or execution of a local AI model, and/or prior to storing the collected data in an AI database (e.g., the local AI database maintained using the AIEF 222, or an external AI database).

AI output processing functions provided by the AIEF 222 may include outputting data (e.g., inference data generated by a local AI model). In some examples, if the AI execution module 220 is implemented in a system node 120 that serves one or more UEs 110, the AI output processing functions may include outputting configuration data to configure a local AI model of a UE 110 served by the system node 120. The AI output processing functions may include providing output data for configuring RRM functions at the system node 120.

AI training functions provided by the AIEF 222 may include carrying out training of a local AI model (using any suitable training algorithm), and may include obtaining real-time network data (e.g., data generated in real-time from real-world operation of the wireless system 100), for example. Training of the local AI model may include initializing parameters the local AI model according to a global AI model (e.g., according to parameters of a global AI model, as provided by the AI management module 210), and updating the parameters (e.g., weights) by training the local AI model on local real-time network data. AI training functions may also include storing the results of the training (e.g., the trained model parameters, such as optimized weights, of the local AI model). The parameters of a trained local AI model (e.g., the optimized weights of a local AI model) may be referred to as local model parameters.

AI execution functions provided by the AIEF 222 may include executing a local AI model (e.g., using locally trained model parameters or using global model parameters provided by the AI management module 210), and outputting the generated inference data (using the AI output processing functions of the AIEF 222). For example, the inference data outputted as a result of execution of the trained local AI model may include one or more control parameters for use in AI-based RRM at the system node 120.

AI database functions provided by the AIEF 222 may include operations for local data collection. For example, if the AI execution module 220 is implemented in a system node 120, the AI database functions may include collecting local data from the system node 120 itself (e.g., network data generated or measured by the system node 120) and/or collecting local data from one or more UEs 110 served by the system node 120 (e.g., network data generated or measured by the UE(s) 110 and/or model data (such as model weights) extracted from local AI model(s) implemented at the UE(s) 110). If the AI execution module 220 is implemented in a UE 110, the AI database functions may include collecting local data from the UE 110 itself (e.g., network data generated or measured by the UE 110 itself). The collected data may be stored in a local AI database, and may be used for training local AI models. Data maintained in the global AI database may include network data (e.g., measurements of network performance, monitored network characteristics, etc.) and may also include model data (e.g., local model parameters, such as model weights). The AI database functions may also include standard database management functions, such as backup and recovery functions, archiving functions, etc.

Each of the AI management module 210 and the AI execution modules 220 also provides AI-base control functions (AICF) 214, 224. As illustrated in FIGS. 1A-1C, the AICF 214 is generally co-located with the AIMF 212 in the AI management module 210, and the AICF 224 is generally co-located with the AIEF 222 in the AI execution module 220. The AICF 214 of the AI management module 210 and the AICF 224 of the AI execution modules 220 may be similar, differing only in context (e.g., the AICF 214 of the AI management module 210 processes inputs and outputs for the AIMF 212; and the AICF 224 of the AI execution module 220 processes inputs and outputs for the AIEF 220). Accordingly, the AICF 214 of the AI management module 210 and the AICF 224 of the AI execution modules 220 will be discussed together.

The AICF 214, 224 may include functions for converting (or translating) inference data generated by AI model(s) (global AI model(s) in the case of the AICF 214 in the AI management module 210, and local AI model(s) in the case of the AICF 224 in the AI execution module 220) into a format suitable for configuring a control module for wireless communications (e.g., output from an AI model may be in an AI-specific language or format that is not recognizable by the control module). For example, a global AI model may generate inference data that indicates a coding scheme to use, where the coding scheme is indicated by a label or AI model output codeword(s) (e.g., encoded as a one-hot vector). The AICF 214 may convert the label into a coding scheme index that is recognizable by RRM control modules. The AICF 214, 224 may also include providing a general interface for communication with other functions and modules in the wireless system 100. For example, the AICF 214, 224 may provide application programming interfaces (APIs) for communications between the AI management module 210 and the AI execution module 220, between the AI execution module 220 and control modules (e.g., software modules related to wireless communication functionality) of the system node 120, between the AI execution module 220 and one or more UEs 110, etc. In generation, an API is a computing interface that defines interactions between multiple software intermediaries. An API typically defines the calls or requests that can be made, how to make them, and the data formats that should be used.

The AICF 214, 224 may also include distributing control parameters generated by AI model(s) (global AI model(s) in the case of the AICF 214 in the AI management module 210, and local AI model(s) in the case of the AICF 224 in the AI execution module 220) to appropriate system control modules.

The AICF 214, 224 may also facilitate data collection by providing a common interface for communication of AI-related data between the AI execution module 220 and the AI management module 210. For example, the AICF 214, 224 may be responsible for implementing the AI-based protocol as disclosed herein.

The AICF 214, 224 may provide a common interface to enable global and/or local AI models to be managed, owned and/or updated by any other entity in the wireless system 100, including an external network 150 or third-party service.

As previously mentioned, the AI management module 210 and the AI execution modules 220 provide multi-level (or hierarchical) AI management and control in the wireless system 100, where the AI management module 210 is responsible for global (or centralized) operations and the AI execution modules 220 are responsible for local operations. Further, the AI management module 210 manages global AI models, including collection of global data and training the global AI models. Each AI execution module 220 performs operations to collect local data at each system node 120 (and optionally from one or more UEs 110). The local data collected at each system node 120 (and optionally from each UE 110) may be collected by the AI management module 210 (using the AIMF 212 and AICF 214) and aggregated to the global data. It should be noted that the global data is typically collected in a non-real-time (non-RT) manner (e.g., at time intervals on the order of 1 ms to about 1s), and one or more global AI models may be trained (using the AIMF 212) also in a non-RT manner, after the global AI database has been updated with the collected global data. Accordingly, the AI management module 210 may perform operations to train a global AI model to perform inference for baseline (and slow to change) wireless functions, such as inferring global parameters for mobility control and MAC control. A global AI model may also be trained to perform inference for baseline performance of more dynamic wireless functions, for example as a starting point for executing and/or further training of a local AI model.

An example of inference data that may be outputted by a trained global AI model may be inferring power control for MAC layer control (e.g., generating inference output for the expected received power level Po, compensation factor alpha, etc.). Another example may be using a trained global AI model to infer parameters for performing massive multiple-input multiple-output (massive MIMO) (e.g., generating inference output for rank, antenna, pre-coding, etc.). Another example may be using a trained global AI model to infer parameters for beamforming optimization (e.g., generating inference output for configuring multiple beam directions, gain configurations, etc.). Other examples of inference data that may be outputted by a trained global AI model my include inferring parameters for inter-RAN or inter-cell resource allocation to enhance resource utilization efficiency or reduce the inter-cell/RAN interference, MAC scheduling in one cell or cross-cell scheduling, among other possibilities.

Compared to the global data collection and global AI model training performed by the AI management module 210, the local data collection and local AI model training performed by the AI execution module 220 may be considered to be dynamic and in real-time or near-real-time (near-RT). The local AI model may be trained to adapt to the varying conditions of the local, dynamic network environment, to enable timely and responsive adjustment of parameters. The collection of local network data and training of local AI models by the AI execution module 220 is typically performed in real-time or near-RT (e.g., at time intervals on the order of several microseconds to several milliseconds). Training of local AI models may be performed using relatively quick training algorithms (e.g., requiring fewer training iterations compared to training of global AI models). For example, a trained local AI model may be used to infer parameters for radio resource control for the functionalities of the CU and DU logical layers of a system node 120 (e.g., parameters for controlling functionalities such as mobility control, RLC MAC, as well as PHY parameters such as remote radio unit (RRU)/antenna configurations). The AI execution module 220 may configure control parameters semi-statically (e.g., using RRC signaling), based on inference data generated by a local AI model and/or based on configuration information in a configuration message from the AI management module 210.

In general, the AI management module 210 and the AI execution module 220 may be used to implement AI-based wireless communications, in particular AI-based control of wireless communication functionalities. The AI management module 210 is responsible for global (or centralized training) of global AI models, to generate global (or baseline) control parameters. The AI management module 210 is also responsible for setting the configuration of local AI model(s) (e.g., implemented by the AI execution module 220) as well as the configuration for local data collection. The AI management module 210 may provide model parameters for deploying a local AI model at an AI execution module 220. For example, the AI management module 210 may provide global model parameters, including coarsely tuned or baseline-trained parameters (e.g., model weights) that may be used to initialize a local AI model and that may be further updated to adapt to the local network data collected by the AI execution module 220.

Configuration information (e.g., configuration information for implementing local AI model(s), configuration information for collection of local data, etc.) from the AI management module 210 may be communicated to a system node 120 in the form of configuration message(s) (e.g., radio resource control (RRC) or downlink control information (DCI) message(s)) that can be received and recognized by the AI execution module 220. The AI execution module 220 may (e.g., using the AICF 224) convert the configuration information from the AI management module 210 into standardized configuration control to be implemented by the system node 120 itself and/or one or more UEs 110 associated with the system node 120. Configuration information communicated by the AI management module 210 may include parameters for configuring individual control modules of the system node 120 and/or UE 110, and may also include parameters for configuration of the system node 120 and/or UE 110 (e.g., configuration of operations to measure and collect local data). As will be discussed further below, communications between the AI management module 210 and the AI execution module 220 enable continuous collection of data and continuous updating of AI models, to enable responsive control of wireless functionality in a dynamically varying network environment.

The present disclosure describes global AI models and local AI models (generally referred to as AI models) designed to generate inference data related to optimization of wireless communication functionalities. It should be understood that, in the context of the present disclosure, an AI model may be designed to generate inference data that is not related to just a single, specific optimization feature (e.g., using an AI module to perform channel estimation). Rather, an AI model may be designed and deployed to generate inference data that may optimize control parameters for one or more control modules related to wireless communications. Each AI model may be defined by an associated task that the AI model is designed for (e.g., an associated network task, such as providing a network service or network requirement). Further, each AI model may be defined by a set of one or more input-related attributes (defining the type or characteristic of data that can be used as input by the AI model) and also may be defined by a set of one or more output-related attributes (defining the type or characteristic of data is generated by the AI model as output). Some examples are discussed below, however these are not intended to be limiting.

In the context of the present disclosure, a requested service is considered to be a type of requested task (e.g., the task is to provide the requested service, such as providing a network service or providing collaborative training of an AI model). Accordingly, the term task in the present disclosure should be understood to include providing a service. A given task that is a network task may have multiple network requirements to be satisfied, which may include satisfying multiple KPIs. For example, an ultra-reliable low-latency communication (URLLC) service in a wireless network may need to satisfy associated KPIs including latency (e.g., latency of no more than 2 ms end-to-end) and reliability (e.g., reliability of 99.9999% or higher) requirements. One or more AI models may be associated with respective one or more tasks for achieving the network requirements. The task associated with a given AI model may be defined at the time the AI model is developed, for example.

The AI management module 210 has access to multiple global AI models (e.g., 100 different global AI models or more), each defined by an associated task. For example, the AI management module 210 may manage or have access to a repository of global AI models that have been developed for various tasks, such as various network tasks. The AI management module 210 may receive a task request (e.g., from a customer of the wireless system 100, or from a node within the wireless system 100), which may be associated with one or more task requirements such as one or more KPIs to be satisfied (e.g., a required latency, required QoS, required throughput, etc.), an application type to service, a traffic type to service, or other such requirements. The AI management module 210 may analyze the requirements (including KPI requirements) associated with the task request, and select one or more global AI models that are associated with a respective task for achieving the requirements. The selected one or more global AI models may individually or together generate inferred control parameters for achieving the requirements. The selection of which global AI model(s) to use for a given task may be based on not only the associated task defined for each global AI model, but also may be based on the set of input-related attributes and/or the set of output-related attributes defined for each global AI model. For example, if a given tasks is a network task that relates to a specific traffic type (e.g., video traffic), then the AI management module 210 may select a global AI model whose input-related attributes indicate that measurements of video traffic network data are accepted as input data to the global AI model.

The set of input-related attributes associated with a given AI model may be a subset of all possible input-related attributes accepted by the AI management module 210 (e.g., as defined by a network standard). For example, the AI management module 210 may provide an interface (e.g., using functions of the AICF 214) to accept input data having attributes are defined by a network standard. For example, input-related attributes may define one or more of: what type(s) of raw data generated by the wireless network may be accepted as input data; what output(s) generated by one or more other AI models may be accepted as input data; what type(s) of network data or measurement collected from a UE 110 and/or system node 120 may be used for training (e.g., pilot signals, decoded sidelink control information (SCI), latency measurement, throughput measurement, signal-to-inference-plus-noise ratio (SINR) measurement, interference measurement, etc.); acceptable format(s) of input data for training; one or more APIs for interacting with other software modules (e.g., to receive input data); which system node(s) 120 and/or UE(s) 110 can participate in providing input data to the AI model; and/or one or more data transfer protocols to be used for communicating input data; among others.

The set of output-related attributes associated with a given AI model may be a subset of all possible output-related attributes for the AI management module 210 (e.g., as defined by a network standard). For example, the AI management module 210 may provide an interface (e.g., using functions of the AICF 214) to output data having attributes are defined by a network standard. For example, output-related attributes may define one or more of: which system node(s) 120 and/or UE(s) 110 are the target of the inference output; and/or which control parameter(s) are the target of the inference output (e.g., mobility control parameters, inter-AN resource allocation parameters, intra-AN resource allocation parameters, power control parameters, MAC scheduling parameters, modulation and coding scheme (MCS) options, automatic repeat request (ARQ) or hybrid ARQ (HARQ) scheme options, waveform options, MIMO or antenna configuration parameters, beamforming configuration parameters, etc.; among others.

Based on the associated task defined for a global AI model, and optionally also based on the set of input-related attributes and/or the set of output-related attributes defined for the global AI model, the AI management module 210 may identify one or more global AI models for performing a task, in accordance with a task request. The AI management module 210 may train the selected global AI model(s) on non-RT global data, and execute the trained global AI model(s) to generate one or more globally inferred control parameters. The globally inferred control parameter(s) may be communicated as configuration information to one or more AI execution modules 220, to configure one or more system nodes 120 and/or UEs 110. The AI management module 210 may also communicate the trained global model parameters (e.g., trained weights) of the global AI model(s) as part of the configuration information. The model parameters may be used at the one or more AI execution modules 220 to configure corresponding local AI model(s) (e.g., to initialize the model parameters of local AI model(s)). The configuration information may also configure the one or more AI execution modules 220 to collect local network data relevant to the task. The control parameter(s) and the model parameters communicated by the AI management module 210 may be sufficient to configure the system node(s) 120 and/or UE(s) 110 to satisfy the task (i.e., without the AI execution module(s) 220 performing further training of the local AI model(s) using local network data). In other example, the AI execution module(s) 220 may perform near-RT training of the local AI model(s), using collected local network data, to adapt the local AI model(s) to the dynamic local network environment and to generate updated local control parameter(s) that may better satisfy the task locally.

For example, if the AI management module 210 receives a task request for low latency service, a global AI model designed to control for latency sensitivity may be selected to infer control parameters for associated control modules (e.g., control parameters for MAC scheduling, power control, beamforming, mobility control, etc.). The AI management module 210 may perform baseline, non-RT training of the selected global AI model(s) to generate one or more globally inferred control parameters related to latency. The trained global model parameters (e.g., trained weights) and/or globally inferred control parameter(s) may then be communicated by the AI management module 210 to be implemented in one or more system nodes 120. For example, the global model parameters may be implemented in corresponding local AI model(s) by the AI execution module 220 at a given system node 120. The local AI model(s) may be executed (using the global model parameters) to generate local control parameter(s) related to latency. The local AI model(s) may be optionally updated (using near-RT training) using local network data collected at the system node 120. The updated local AI model(s) may then be executed to infer updated local control parameter(s) to control for latency, according to the dynamic local environment of the system node 120.

It should be understood that the present disclosure is not intended to be limited by the inference data that may be generated by an AI model (whether a global AI model or a local AI model) or the task that may be addressed by an AI model in the context of a wireless network. Further, it should be understood that an AI model may be designed and trained to output an inference data that optimizes more than one parameter (e.g., to infer optimized parameters for multiple power control parameters), and the present disclosure should not be limited to any specific type of AI model.

Thus, the present disclosure describes a task-driven approach to defining AI models (including global AI models and local AI models). In addition to the task (which may be a network task, including network services) defined for each AI model, each AI model may be defined by a set of input-related attributes and a set of output-related (or inference-related) attributes. Defining an AI model based on the task to be addressed, the inputs and the outputs may enable any AI developer to develop and provide an AI model according to the definition. This may simplify the process of developing and implementing new AI models, and may enable greater participation from third-party AI services.

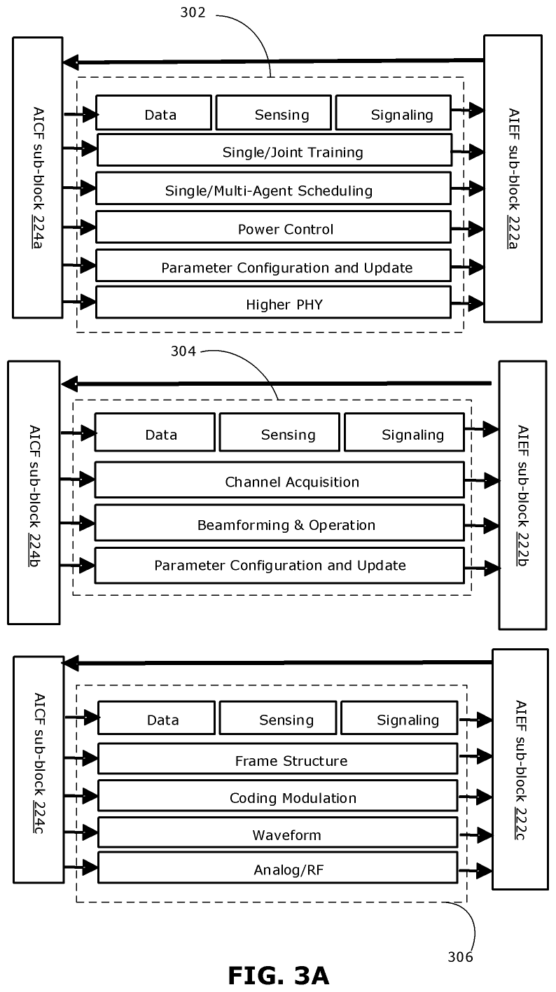

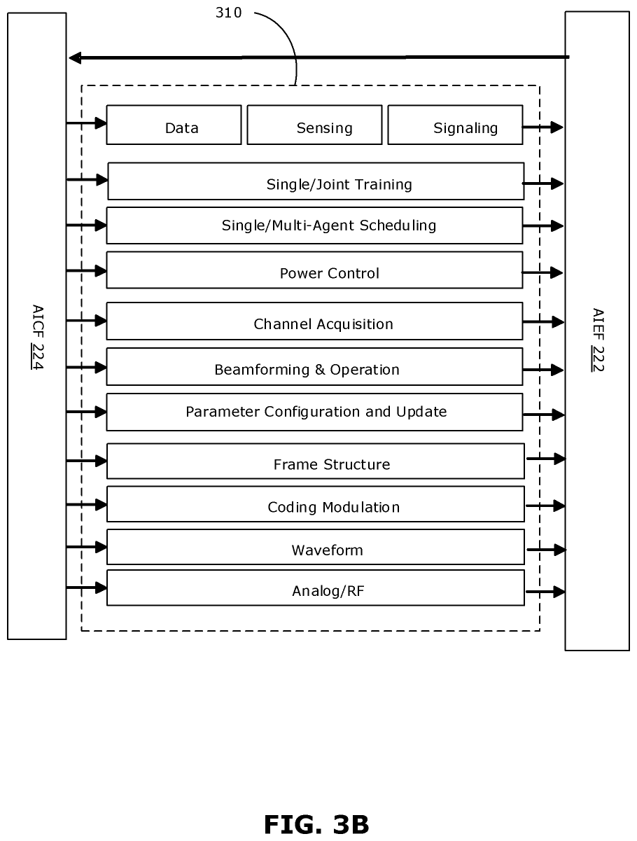

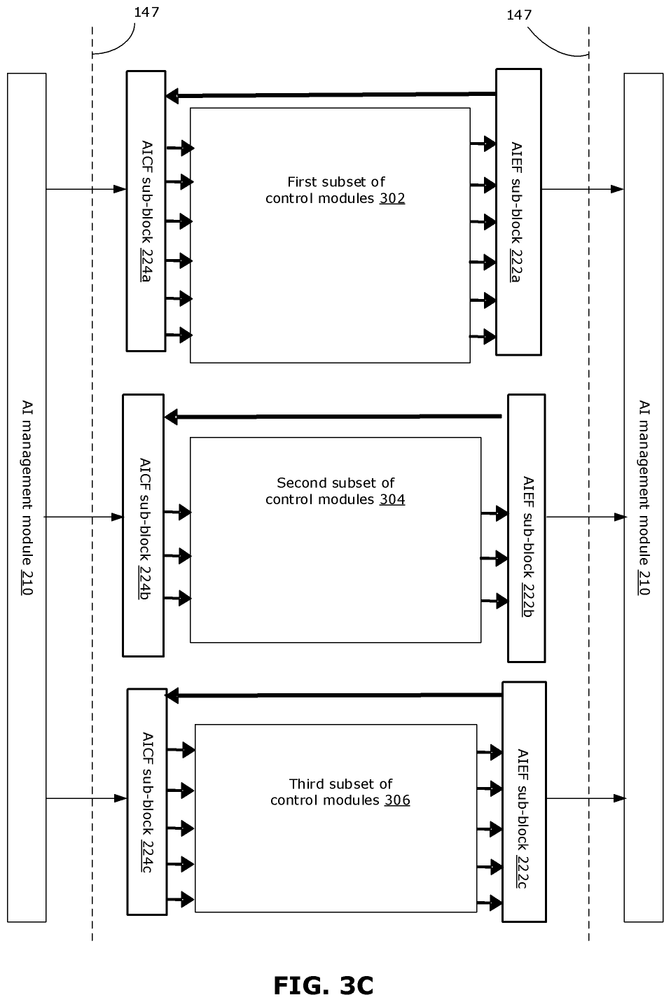

FIGS. 3A-3C illustrate examples of how logical layers of a system node 120 or UE 110 may communicate with the AI execution module 220. For ease of understanding, the AIEF 222 and the AICF 224 of the AI execution module 220 are illustrated as separated blocks (and in some cases illustrated as separate sub-blocks). However, it should be understood that the AIEF 222 and the AICF 224 blocks and sub-blocks are not necessary independent functional blocks, and that the AIEF 222 and the AICF 224 blocks and sub-blocks may be intended to function together within AI execution module 220.

FIG. 3A shows an example of a distributed approach to controlling the logical layers. In this example, the AIEF 222 and AICF 224 are logically divided into sub-blocks 222a-c and 224a-c, respectively, to control the control modules of the system node 120 or UE 110 corresponding to different logical layers. The sub-blocks 222a-c may be logical divisions of the AIEF 222, such that the sub-blocks 222a-c all perform similar functions but are responsible for controlling a defined subset of the control modules of the system node 120 or UE 110. Similarly, the sub-blocks 224a-c may be logical divisions of the AICF 224, such that the sub-blocks 224a-c all perform similar functions but are responsible for communicating with a defined subset of the control modules of the system node 120 or UE 110. This may enable each sub-block 222a-c and 224a-c to be located more closely to the respective subset of control modules, which may allow for faster communication of control parameters to the control modules.

In the example of FIG. 3A, a first logical AIEF sub-block 222a and a first logical AICF sub-block 224a provide control to a first subset of control modules 302. For example, the first subset of control modules 302 may control functions of the higher PHY layers (e.g., single/joint training functions, single/multi-agent scheduling functions, power control functions, parameter configuration and update functions, and other higher PHY functions). In operation, the AICF sub-block 224a may output one or more control parameters (e.g., received from the AI management module 210 and/or generated by one or more local AI models and outputted by the AIEF sub-block 222a) to the first subset of control modules 302. Data generated by the first subset of control modules 302 (e.g., network data collected by the control modules 302, such as measurement data and/or sensed data, which may be used for training local and/or global AI models) are received as input by the AIEF sub-block 222a. The AIEF sub-block 222a may, for example, preprocess this received data and use the data as near-RT training data for one or more local AI models maintained by the AI execution module 220. The AIEF sub-block 222a may also output inference data generated by one or more local AI models to the AICF sub-block 224a, which in turn interfaces (e.g., using a common API) with the first subset of control modules 302 to provide the inference data as control parameters to the first subset of control modules 302.

A second logical AIEF sub-block 222b and a second logical AICF sub-block 224b provide control to a second subset of control modules 304. For example, the second subset of control modules 304 may control functions of the MAC layer (e.g., channel acquisition functions, beamforming and operation functions, and parameter configuration and update functions, as well as functions for receiving data, sensing and signaling). The operation of the AICF sub-block 224b and the AIEF sub-block 222b to control the second subset of the control modules 304 may be similar to that described above.

A third logical AIEF sub-block 222c and a third logical AICF sub-block 224c provide control to a third subset of control modules 306. For example, the third subset of control modules 306 may control functions of the lower PHY layers (e.g., controlling the frame structure, coding modulation, waveform, and analog/radiofrequency (RF) parameters). The operation of the AICF sub-block 224c and the AIEF sub-block 222c to control the third subset of the control modules 306 may be similar to that described above.

FIG. 3B shows an example of an undistributed (or centralized) approach to controlling the logical layers. In this example, the AIEF 222 and AICF 224 control all control modules 310 of the system node 120 or UE 110, without division by logical layer. This may enable more optimized control of the control modules. For example, a local AI model may be implemented at the AI execution module 220 to generate inference data for optimizing control at different logical layers, and the generated inference data may be provided by the AIEF 222 and AICF 224 to the corresponding control modules, regardless of the logical layer.

The AI execution module 220 may implement the AIEF 222 and AICF 224 in a distributed manner (e.g., as shown in FIG. 3A) or an undistributed manner (e.g., as shown in FIG. 3B). Different AI execution modules 220 (e.g., implemented at different system nodes 120 and/or different UEs 110) may implement the AI execution module 220 in different ways. The AI management module 210 may communicate with the AI execution module 220 via an open interface whether a distributed or undistributed approach is used at the AI execution module 220.

FIG. 3C illustrates an example of the AI management module 210 communicating with the sub-blocks 222a-c and 224a-c via an open interface, such as the interface 147 as illustrated in FIG. 1B or FIG. 1C (although the interface 147 is shown, it should be understood that other interfaces may be used). In this example, the AIEF 222 and AICF 224 are implemented in a distributed manner, and accordingly the AI management module 210 provides distributed control of the sub-blocks 222a-c and 224a-c (e.g., the AI management module 210 may have knowledge of which sub-blocks 222a-c and 224a-c communicate with which subset of control modules). It should be noted that FIG. 3C shows two instances of the AI management module 210 in order to illustrate the flow of communication, however there may be only one instance of the AI management module 210 in actual implementation. Data from the AI management module 210 (e.g., control parameters, model parameters, etc.) may be received by the AICF sub-blocks 224a-c via the interface 147, and used to control the respective control modules. Data from the AIEF sub-blocks 222a-c (e.g., model parameters of local AI models, inference data generated by local AI models, collected local network data, etc.) may be outputted to the AI management module 210 via the interface 147.

Communication of AI-related data (e.g., collected network data, model parameters, etc.) may be performed over an AI-related protocol. The present disclosure describes an AI-related protocol that is communicated over a higher level AI-dedicated logical layer. In some embodiments of the present disclosure, an AI control plane is disclosed.

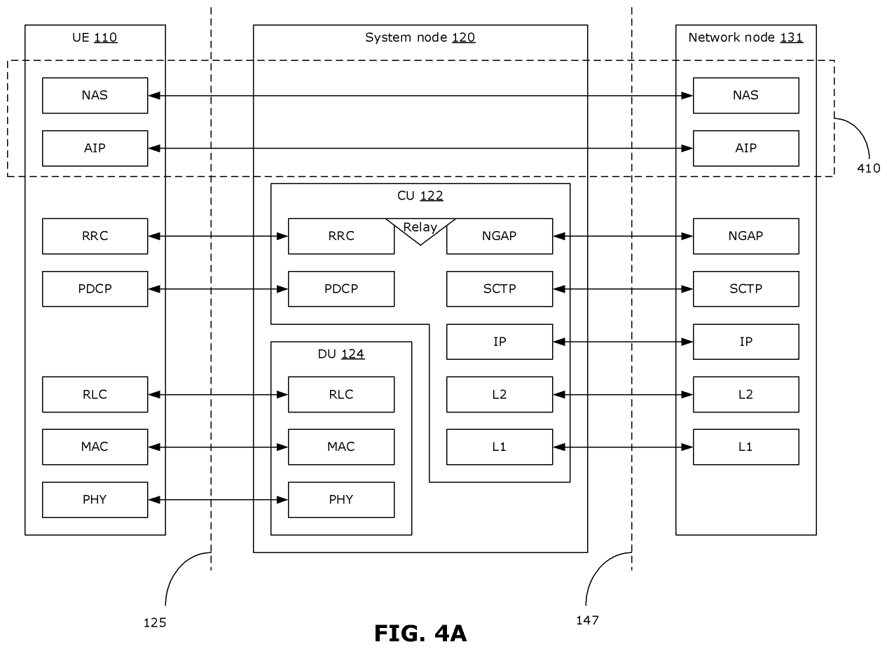

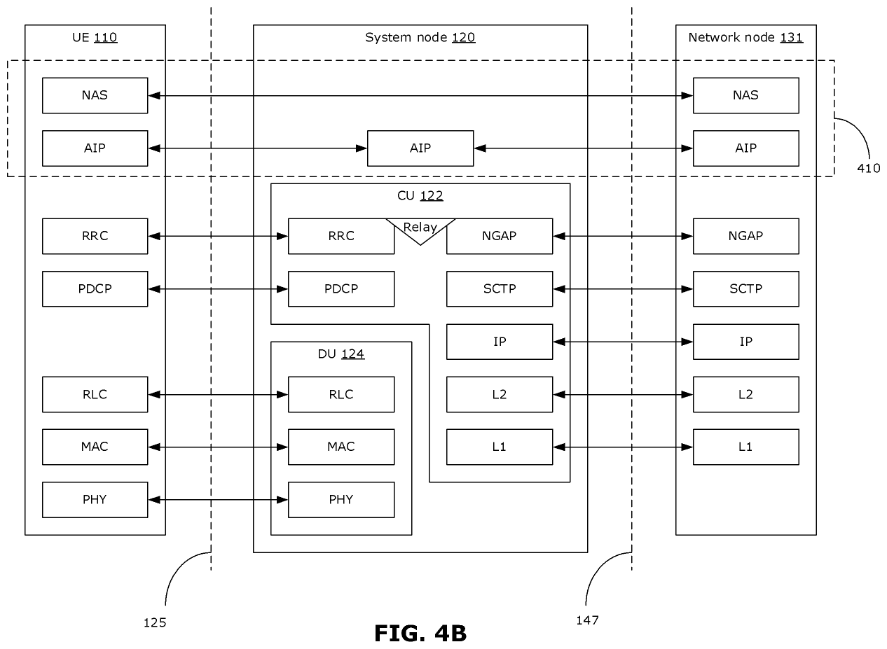

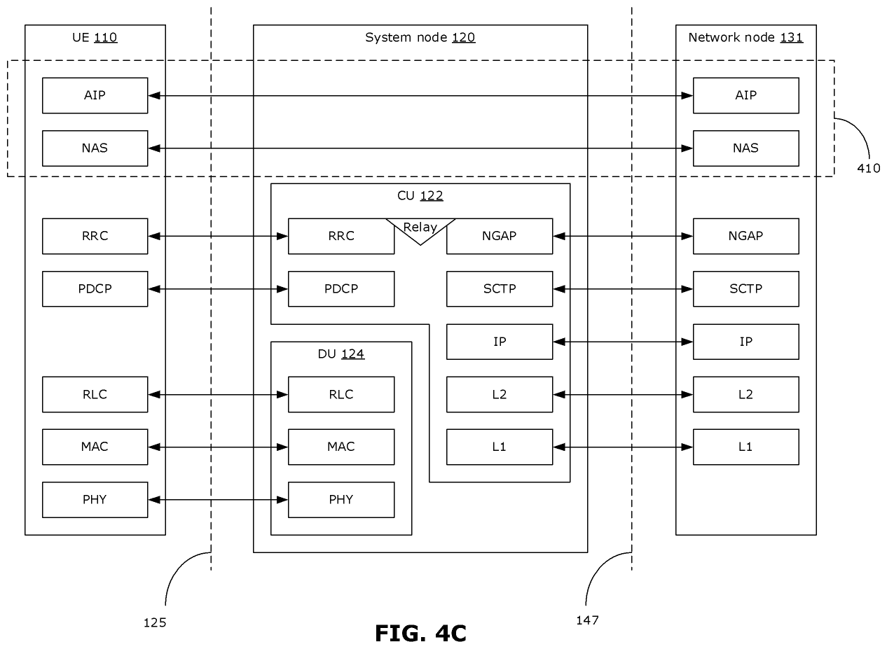

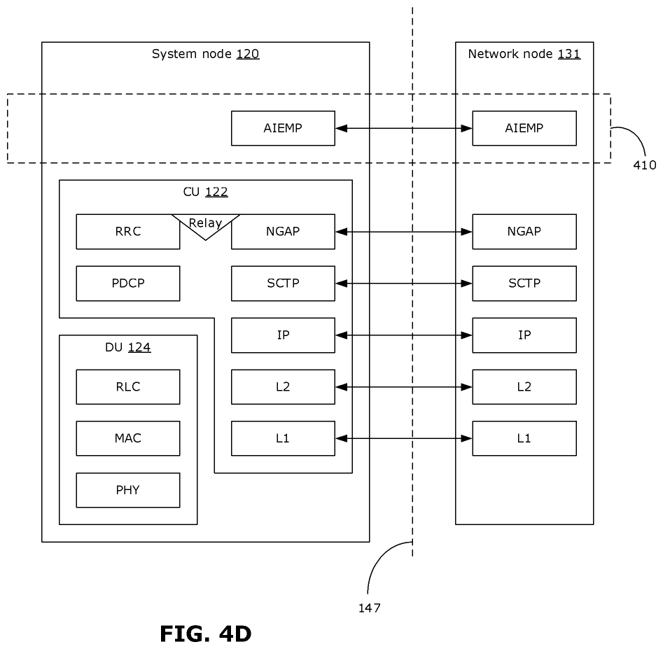

FIG. 4A is a block diagram illustrating an example implementation of an AI control plane (A-plane) 410 on top of the existing protocol stack as defined in 5G standards. In existing 5G standards, the protocol stack at the UE 110 includes, from the lowest logical level to the highest logical level, the PHY layer, the MAC layer, the RLC layer, the PDCP layer, the RRC layer, and the non-access stratum (NAS) layer. At the system node 120, the protocol stack may be split into the centralized unit (CU) 122 and the distributed unit (DU) 124. It should be noted that the CU 122 may be further split into CU control plane (CU-CP) and CU user plane (CU-UP). For simplicity, only the CU-CP layers of the CU 122 are shown in FIG. 4A. In particular, the CU-CP may be implemented in a system node 120 that implements the AI execution module 220 for the AN. In the example shown, the DU 124 includes the lower level PHY, MAC and RLC layers, which facilitate interactions with corresponding layers at the UE 110. In this example, the CU 122 includes the higher level RRC and PDCP layers. These layers of the CU 122 facilitate control plane interactions with corresponding layers at the UE 110. The CU 122 also includes layers responsible for interactions with the network node 131 in which the AI management module 210 is implemented, including (from low to high) the L1 layer, the L2 layer, the internet protocol (IP) layer, the stream control transmission protocol (SCTP) layer, and the next-generation application protocol (NGAP) layer (each of which facilitates interactions with corresponding layers at the network node 131). A communication relay in the system node 120 couples the RRC layer with the NGAP layer. It should be noted that the division of the protocol stack into the CU 122 and the DU 124 may not be implemented by the UE 110 (but the UE 110 may have similar logical layers in the protocol stack).

FIG. 4A shows an example in which the UE 110 (where the AI execution module 220 is implemented at the UE 110) communicates AI-related data with the network node 131 (where the AI management module 210 is implemented), where the system node 120 is transparent (i.e., the system node 120 does not decrypt or inspect the AI-related data communicated between the UE 110 and the network node 131). In this example, the A-plane 410 includes higher layer protocols, such as an AI-related protocol (AIP) layer as disclosed herein, and the NAS layer (as defined in existing 5G standards). The NAS layer is typically used to manage the establishment of communication sessions and for maintaining continuous communications between the core network 130 and the UE 110 as the UE 110 moves. The AIP may encrypt all communications, ensuring secure transmission of AI-related data. The NAS layer also provides additional security, such as integrity protection and ciphering of NAS signaling messages. In existing 5G protocol stacks, the NAS layer is the highest layer of the control plane between the UE 110 and the core network 130, and sits on top of the RRC layer. In the present disclosure, the AIP layer is added, and the NAS layer is included with the AIP layer in the A-plane 410. At the network node 131, the AIP layer is added between the NAS layer and the NGAP layer. The A-plane 410 enables secure exchange of AI-related information, separate from the existing control plane and data plane communications. It should be noted that, in the present disclosure, AI-related data that may be communicated to the network node 131 (e.g., from the UE 110 and/or system node 120) may include raw (i.e., unprocessed or minimally processed) local data (e.g., raw network data) as well as processed local data (e.g., local model parameters, inferred data generated by local AI model(s), anonymized network data, etc.). Raw local data may be unprocessed network data that can include sensitive user data (e.g., user photographs, user videos, etc.), and thus it may be important to provide a secure logical layer for communication of such sensitive AI-related data.

The AI execution module 220 at the UE 110 may communicate with the system node 120 over an existing air interface 125 (e.g., a Uu link as currently defined in 5G wireless technology), but over the AIP layer to ensure secure data transmission. The system node 120 may communicate with the network node 131 over an AI-related interface (which may be a backhaul link currently not defined in 5G wireless technology), such as the interface 147 shown in FIG. 4A. However, it should be understood that communication between the network node 131 and the system node 120 may alternatively be via any suitable interface (e.g., via interfaces to the core network 130, as shown in FIG. 1A). The communications between the UE 110 and the network node 131 over the A-plane 410 may be forwarded by the system node 120 in a completely transparent manner.

FIG. 4B illustrates an alternative embodiment. FIG. 4B is similar to FIG. 4A, however the AI execution module 220 at the system node 120 is involved in communications between the AI execution module 220 at the UE 110 and the AI management module 210 at the network node 131. As shown in FIG. 4B, the system node 120 may process AI-related data using the AIP layer (e.g., decrypt, process and re-encrypt the data), as an intermediary between the UE 110 and the network node 131. The system node 120 may make use of the AI-related data from the UE 110 (e.g., to perform training of a local AI model at the system node 120. The system node 120 may also simply relay the AI-related data from the UE 110 to the network node 130. This may expose UE data (e.g., network data locally collected at the UE 110) to the system node 120 as a tradeoff for the system node 120 taking on the role of processing the data (e.g., formatting the data into an appropriate message) for communication to the AI management module 210 and/or to enable the system node 120 to make use of the data from the UE 110. It should be noted that communication of AI-related data between the UE 110 and the system node 120 may also performed using the AIP layer in the A-plane 410 between the UE 110 and the system node 120.

FIG. 4C illustrates another alternative embodiment. FIG. 4C is similar to FIG. 4A, however the NAS layer sits directly on top of the RRC layer at the UE 110, and the AIP layer sits on top of the NAS layer. At the network node 131, the AIP layer sits on top of the NAS layer (which sits directly on top of the NGAP layer). This embodiment may enable the existing protocol stack configuration to be largely preserved, while separating the NAS layer and the AIP layer into the A-plane 410. In this example, the system node 120 is transparent to the A-plane 410 communications between the UE 110 and the network node 131. However, the system node 120 may also act as an intermediary to process AI-related data, using the AIP layer, between the UE 110 and the network node 131 (e.g., similar to the example shown in FIG. 4B).

FIG. 4D is a block diagram illustrating an example of how the A-plane 410 is implemented for communication of AI-related data between the AI execution module 220 at the system node 120 and the AI management module 210 at the network node 131. The communication of AI-related data between the AI execution module 220 at the system node 120 and the AI management module 210 at the network node 131 may be over an AI execution/management protocol (AIEMP) layer. The AIEMP layer may be different from the AIP layer between the UE 110 and the network node 131, and may provide an encryption that is different from or similar to the encryption performed on the AIP layer. The AIEMP may be a layer of the A-plane 410 between the system node 120 and the network node 131, where the AIEMP layer may be the highest logical layer, above the existing layers of the protocol stack as defined in 5G standards. The existing layers of the protocol stack may be unchanged. Similarly to the communication of AI-related data from the UE 110 to the network node 131 (e.g., as described with respect to FIG. 4A), the AI-related data that is communicated from the system node 120 to the network node 131, using the AIEMP layer, may include raw local data and/or processed local data. FIGS. 4A-4D illustrate communication of AI-related data over the A-plane 410 using the interfaces 125 and 147, which may be wireless interfaces. In some examples, communication of AI-related data may be over wireline interfaces. For example, communication of AI-related data between the system node 120 and the network node 131 may be over a backhaul wired link.

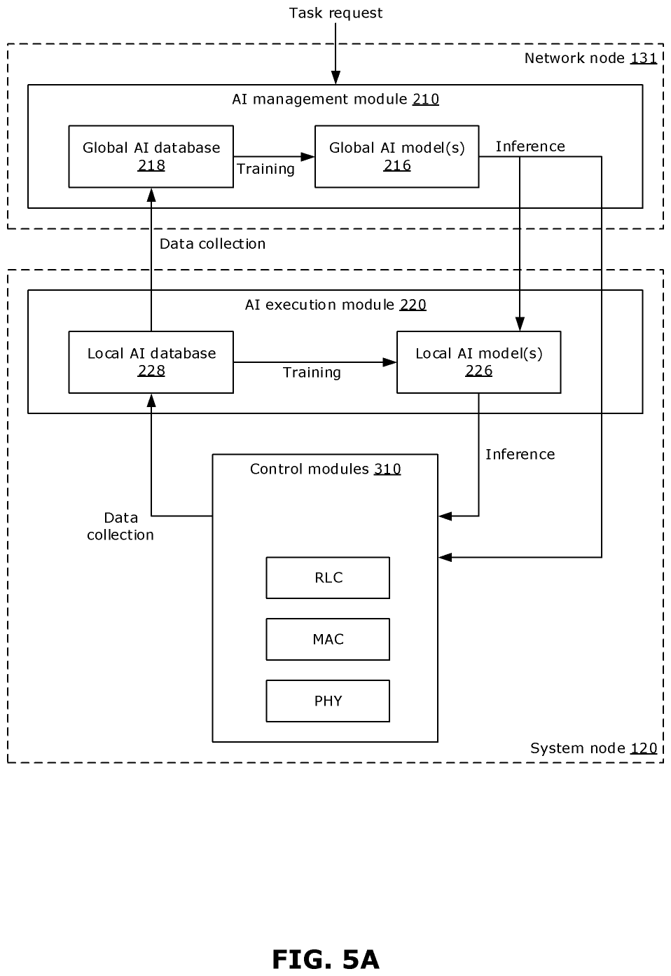

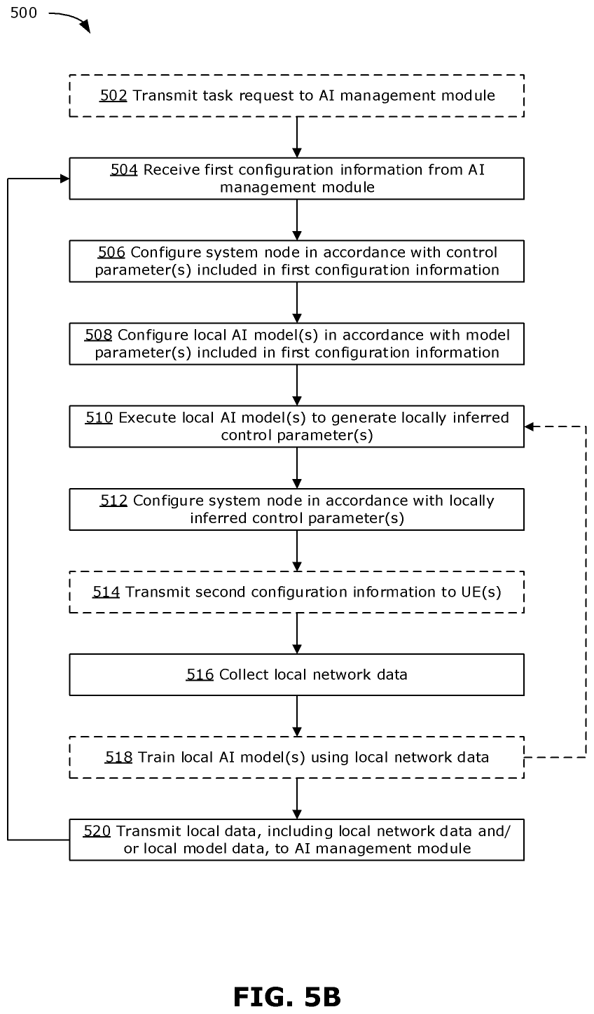

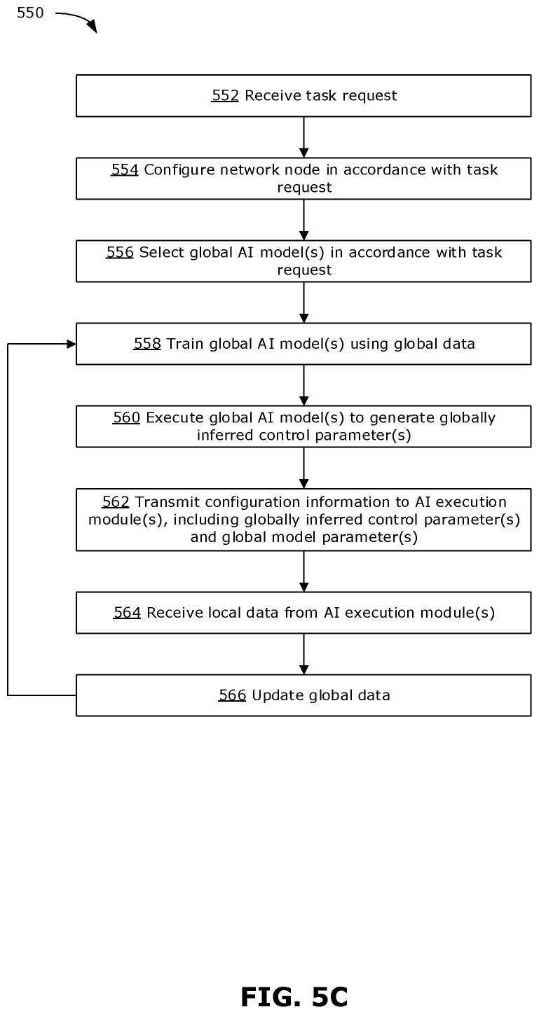

FIG. 5A is a simplified block diagram illustrating an example dataflow in an example operation of the AI management module 210 and the AI execution module 220. In this example, the AI execution module 220 is implemented in a system node 120, such as the BS of an AN. It should be understood that similar operations may be carried out if the AI execution module 220 is implemented in a UE 110 (and the system node 120 may be an intermediary to relay the AI-related communications between the UE 110 and the network node 131). Further, communications to and from the network node 131 may or may not be relayed through the core network 130.

A task request is received by the AI management module 210. An example is first described in which the task request is a network task request. The network task request may be any request for a network task, including a request for a service, and may include one or more task requirements, such as one or more KPIs (e.g., latency, QoS, throughput, etc.) and/or application attributes (e.g., traffic types, etc.) related to the network task. The task request may be received from a customer of the wireless system 100, from an external network 150, and/or from nodes within the wireless system 100 (e.g., from the system node 120 itself).

At the AI management module 210, after receiving the task request, the AI management module 210 performs functions (e.g., using functions provided by the AIMF 212 and/or AICF 214) to perform initial setup and configuration based on the task request. For example, the AI management module 210 may use functions of the AICF 214 to set the target KPI(s) and application or traffic type for the network task, in accordance with the one or more task requirements included in the task request. The initial setup and configuration may include selection of one or more global AI models 216 (from among a plurality of available global AI models 216 maintained by the AI management module 210) to satisfy the task request. The global AI models 216 available to the AI management module 210 may be developed, updated, configured and/or trained by an operator of the core network 130, other operators, an external network 150, or a third-party service, among other possibilities. The AI management module 210 may select one or more selected global AI models 216 based on, for example, matching the definition of each global AI model (e.g., the associated task, the set of input-related attributes and/or the set of output-related attributes defined for each global AI model) with the task request. The AI management module 210 may select a single global AI model 216, or may select plurality of global AI models 216 to satisfy the task request (where each selected global AI model 216 may generate inference data that addresses a subset of the task requirements).

After selecting the global AI model(s) 216 for the task request, the AI management module 210 performs training of the global AI model(s) 216, for example using global data from a global AI database 218 maintained by the AI management module 210 (e.g., using training functions provided by the AIMF 212). The training data from the global AI database 218 may include non-RT data (e.g., may be older than several milliseconds, or older than one second), and may include network data and/or model data collected from one or more AI execution modules 220 managed by the AI management module 210. After training is complete (e.g., the loss function for each global AI model 216 has converged), the selected global AI model(s) 216 are executed to generate a set of global (or baseline) inference data (e.g., using model execution functions provided by the AIMF 212). The global inference data may include globally inferred (or baseline) control parameter(s) to be implemented at the system node 120. The AI management module 210 may also extract, from the trained global AI model(s), global model parameters (e.g., the trained weights of the global AI model(s)), to be used by local AI model(s) at the AI execution module 220. The globally inferred control parameter(s) and/or global model parameter(s) are communicated (e.g., using output functions of the AICF 214) to the AI execution module 220 as configuration information, for example in a configuration message.

At the AI execution module 220, the configuration information is received and optionally preprocessed (e.g., using input functions of the AICF 224). The received configuration information may include model parameter(s) that are used by the AI execution module 220 to identify and configure one or more local AI model(s) 226. For example, the model parameter(s) may include an identifier of which local AI model(s) 226 the AI execution module 220 should select from a plurality of available local AI models 226 (e.g., a plurality of possible local AI models and their unique identifiers may be predefined by a network standard, or may be preconfigured at the system node 120). The selected local AI model(s) 226 may be similar to the selected global AI model(s) 216 (e.g., having the same model definition and/or having the same model identifier). The model parameter(s) may also include globally trained weights, which may be used to initialize the weights of the selected local AI model(s) 226. For example, depending on the task request, the selected local AI model(s) 226 may (after being configured using the model parameter(s) received from the AI management module 210) be executed to generate inferred control parameter(s) for one or more of: mobility control, interference control, cross-carrier interference control, cross-cell resource allocation, RLC functions (e.g., ARQ, etc.), MAC functions (e.g., scheduling, power control, etc.), and/or PHY functions (e.g., RF and antenna operation, etc.), among others.

The configuration information may also include control parameter(s), based on inference data generated by the selected global AI model(s) 216, that may be directly used to configure one or more control modules at the system node 120. For example, the control parameter(s) may be converted (e.g., using output functions of the AICF 224) from the output format of the global AI model(s) 216 into control instructions recognized by the control module(s) at the system node 120. The control parameter(s) from the AI management module 210 may be tuned or updated by training the selected local AI model(s) 226 on local network data to generate locally inferred control parameter(s) (e.g., using model execution functions provided by the AIEF 222). In the example where the AI execution module 220 is implemented at the system node 120, the system node 120 may also communicate control parameter(s) (whether received directly from the AI management module 210 or generated using the selected local AI model(s) 226) to one or more UEs 110 (not shown) served by the system node 120.

The system node 120 may also communicate configuration information to the one or more UEs 110, to configure the UE(s) 110 to collect real-time or near-RT local network data. The system node 120 may also configure itself to collect real-time or near-RT local network data. Local network data collected by the UE(s) 110 and/or the system node 120 may be stored in a local AI database 228 maintained by the AI execution module 220, and used for near-RT training of the selected local AI model(s) 226 (e.g., using training functions of the AIEF 222). As previously mentioned, training of the selected local AI model(s) 226 may be performed relatively quickly (compared to training of the selected global AI model(s) 216) to enable generation of inference data in near-RT as the local data is collected (to enable near-RT adaptation to the dynamic real-world environment). For example, training of the selected local AI model(s) 226 may involve fewer training iterations compared to training of the selected global AI model(s) 216. The trained parameters of the selected local AI model(s) 226 (e.g., the trained weights) after near-RT training on local network data may also be extracted and stored as local model data in the local AI database 228.

In some examples, one or more of the control modules at the system node 120 (and optionally one or more UEs 110 served by the RAN 120) may be configured directly based on the control parameter(s) included in the configuration information from the AI management module 210. In some examples, one or more of the control modules at the system node 120 (and optionally one or more UEs 110 served by the RAN 120) may be controlled based on locally inferred control parameter(s) generated by the selected local AI model(s) 226. In some examples, one or more of the control modules at the system node 120 (and optionally one or more UEs 110 served by the RAN 120) may be controlled jointly by the control parameter(s) from the AI management module 210 and by the locally inferred control parameter(s).

The local AI database 228 may be a shorter-term data storage (e.g., a cache or buffer), compared to the longer-term data storage at the global AI database 218. Local data maintained in the local AI database 228, including local network data and local model data, may be communicated (e.g., using output functions provided by the AICF 224) to the AI management module 210 to be used for updating the global AI model(s) 216.

At the AI management module 210, local data collected from one or more AI execution modules 220 are received (e.g., using input functions provided by the AICF 214) and added, as global data, to the global AI database 218. The global data may be used for non-RT training of the selected global AI model(s) 216. For example, if the local data from the AI execution module(s) 220 include the locally-trained weights of the local AI model(s) (if the local AI model(s) have been updated by near-RT training), the AI management module 210 may aggregate the locally-trained weights and use the aggregated result to update the weights of the selected global AI model(s) 216. After the selected global AI model(s) 216 have been updated, the selected global AI model(s) 216 may be executed to generate updated global inference data. The updated global inference data may be communicated (e.g., using output functions provided by the AICF 214) to the AI execution module 220, for example as another configuration message or as an update message. In some examples, the update message communicated to the AI execution module 220 may include only control parameters or model parameters that have changed from the previous configuration message. The AI execution module 220 may receive and process the updated configuration information in the manner described above.

In the example illustrated in FIG. 5A, the AI management module 210 performs continuous data collection, training of selected global AI model(s) 216 and execution of the trained global AI model(s) 216 to generate updated data (including updated globally inferred control parameter(s) and/or global model parameter(s)), to enable continuous satisfaction of the task request (e.g., satisfaction of one or more KPIs included as task requirements in the task request). The AI execution module 220 may similarly perform continuous updates of configuration parameter(s), continuous collection of local network data and optionally continuous training of the selected local AI model(s) 226, to enable continuous satisfaction of the task request (e.g., satisfaction of one or more KPIs included as task requirements in the task request). As illustrated in FIG. 5A, collection of local network data, training of global (or local) AI model(s) and generation of updated inference data (whether global or local) may be performed repeatedly as a loop, at least for the time duration indicated in the task request (or until the task request is updated or replaced), for example.

Another example is now described in which the task request is a collaborative task request. For example, the task request may be a request for collaborative training of an AI model, and may include an identifier of the AI model to be collaboratively trained, an identifier of data to be used and/or collected for training the AI model, a dataset to be used for training the AI model, locally trained model parameters to be used for collaboratively updating a global AI model, and/or a training target or requirement, among other possibilities. The task request may be received from a customer of the wireless system 100, from an external network 150, and/or from nodes within the wireless system 100 (e.g., from the system node 120 itself).

At the AI management module 210, after receiving the task request, the AI management module 210 performs functions (e.g., using functions provided by the AIMF 212 and/or AICF 214) to perform initial setup and configuration based on the task request. For example, the AI management module 210 may use functions of the AICF 214 to select and initialize one or more AI models in accordance with the requirements of the collaborative task (e.g., in accordance with an identifier of the AI model to be collaboratively trained and/or in accordance with parameters of the AI model to be collaboratively updated).

After selecting the global AI model(s) 216 for the task request, the AI management module 210 performs training of the global AI model(s) 216. For collaborative training, the AI management module 210 may use training data provided and/or identified in the task request for training of the global AI model(s) 216. For example, the AI management module 210 may use model data (e.g., locally trained model parameters) collected from one or more AI execution modules 220 managed by the AI management module 210 to update the parameters of the global AI model(s) 216. In another example, the AI management module 210 may use network data (e.g., locally generated and/or collected user data) collected from one or more AI execution modules 220 managed by the AI management module 210, to train the global AI model(s) 216 on behalf of the AI execution module(s) 220. After training is complete (e.g., the loss function for each global AI model 216 has converged), model data extracted from the selected global AI model(s) 216 (e.g., the globally updated weights of the global AI model(s)) may be communicated to be used by local AI model(s) at the AI execution module 220. The global model parameter(s) may be communicated (e.g., using output functions of the AICF 214) to the AI execution module 220 as configuration information, for example in a configuration message.

At the AI execution module 220, the configuration information includes model parameter(s) that are used by the AI execution module 220 to update one or more corresponding local AI model(s) 226 (e.g., the AI model(s) that are the target(s) of the collaborative training, as identified in the collaborative task request). For example, the model parameter(s) may include globally trained weights, which may be used to update the weights of the selected local AI model(s) 226. The AI execution module 220 may then execute the updated local AI model(s) 226. Additionally or alternatively, the AI execution module 220 may continue to collect local data (e.g., local raw data and/or local model data), which may be maintained in the local AI database 228. For example, the AI execution module 220 may communicate newly collected local data to the AI management module 210 to continue the collaborative training.

At the AI management module 210, local data collected from one or more AI execution modules 220 are received (e.g., using input functions provided by the AICF 214) and may be used for collaborative of the selected global AI model(s) 216. For example, if the local data from the AI execution module(s) 220 include the locally-trained weights of the local AI model(s) (if the local AI model(s) have been updated by near-RT training), the AI management module 210 may aggregate the locally-trained weights and use the aggregated result to collaboratively update the weights of the selected global AI model(s) 216. After the selected global AI model(s) 216 have been updated, updated model parameters may be communicated back to the AI execution module 220. This collaborative training, including communications between the AI management module 210 and the AI execution module 220, may be continued until an end condition is met (e.g., the model parameters have sufficiently converged, the target optimization and/or requirement of the collaborative training has been achieved, expiry of a timer, etc.). In some examples, the requestor of the collaborative task may transmit a message to the AI management module 210 to indicate that the collaborative task should end.

It may be noted that, in some examples, the AI management module 210 may participate in a collaborative task without requiring detailed information about the data being used for training and/or the AI model(s) being collaboratively trained. For example, the requestor of the collaborative task (e.g., the system node 120 and/or the UE 110) may define the optimization targets and/or may identify the AI model(s) to be collaboratively trained, and may also identify and/or provide the data to be used for training. In some examples, the AI management module 210 may be implemented by a node that is a public AI service center (or a plug-in AI device), for example from a third-party, that can provide the functions of the AI management module 210 (e.g., AI modeling and/or AI parameter training functions) based on the related training data and/or the task requirements in a request from a customer or a system node 120 (e.g., BS) or UE 110. In this way, the AI management module 210 may be implemented as an independent and common AI node or device, which may provide AI-dedicated functions (e.g., as an AI modeling training tool box) for the system node 120 or UE 110. However, the AI management module 210 might not be directly involved in any wireless system control. Such implementation of the AI management module 210 may be useful if a wireless system wishes or requires its specific control goals to be kept private or confidential but requires AI modeling and training functions provided by the AI management module 210 (e.g., the AI management module 210 need not even be aware of any AI execution module 220 present in the system node 120 or UE 110 that is requesting the task).

Some examples of how the AI management module 210 cooperates with the AI execution module 220 to satisfy a task request are now described. It should be understood that these examples are not intended to be limiting. Further, these examples are described in the context of the AI execution module 220 being implemented at the system node 120. However, it should be understood that the AI execution module 220 may additionally or alternatively be implemented at one or more UEs 110.

An example network task request may be a request for low latency service, such as to service URLLC traffic. The AI management module 210 performs initial configuration to set a latency constraint (e.g., maximum 2 ms delay in end-to-end communication) in accordance with this network task. The AI management module 210 also selects one or more global AI models 216 to address this network task, for example a global AI model associated with URLLC is selected. The AI management module 210 trains the selected global AI model 216, using training data from the global AI database 218. The trained global AI model 216 is executed to generate global inference data that includes global control parameters that enable high reliability communications (e.g., an inferred parameter for a waveform, an inferred parameter for interference control, etc.). The AI management module 210 communicates a configuration message to the AI execution module 220 at the system node 120, including globally inferred control parameter(s) and model parameter(s). The AI execution module 220 outputs the received globally inferred control parameter(s) to configure the appropriate control modules at the system node 120. The AI execution module 220 also identifies and configures the local AI model 226 associated with URLLC, in accordance with the model parameter(s). The local AI model 226 is executed to generate locally inferred control parameter(s) for the control modules at the system node 120 (which may be used in place of or in addition to the globally inferred control parameter(s)). For example, control parameter(s) that may be inferred to satisfy the URLLC task may include parameters for a fast handover switching scheme for URLLC, an interference control scheme for URLLC, a defined cross-carrier resource allocation (to reduce cross-carrier interference), the RLC layer may be configured with no ARQ (to reduce latency), the MAC layer may be configured to use grant-free scheduling or a conservative resource configuration with power control for uplink communications, and the PHY layer may be configured to use an URLLC-optimized waveform and antenna configuration. The AI execution module 220 collects local network data (e.g., channel status information (CSI), air-link latencies, end-to-end latencies, etc.) and communicates the local data (which may include both the collected local network data and the local model data, such as the locally trained weights of the local AI model 226) to the AI management module 210. The AI management module 210 updates the global AI database 218 and performs non-RT training of the global AI model 216, to generate updated inference data. These operations may be repeated to continue satisfying the task request (i.e., enabling URLLC).

Another example network task request may be a request for high throughput, for file downloading. The AI management module 210 performs initial configuration to set a high throughput requirement (e.g., high spectrum efficiency for transmissions) in accordance with this network task. The AI management module 210 also selects one or more global AI models 216 to address this network task, for example a global AI model associated with spectrum efficiency is selected. The AI management module 210 trains the selected global AI model 216, using training data from the global AI database 218. The trained global AI model 216 is executed to generate global inference data that includes global control parameters that enable high spectrum efficiency (e.g., efficient resource scheduling, multi-TRP handover scheme, etc.). The AI management module 210 communicates a configuration message to the AI execution module 220 at the system node 120, including globally inferred control parameter(s) and model parameter(s). The AI execution module 220 outputs the received globally inferred control parameter(s) to configure the appropriate control modules at the system node 120. The AI execution module 220 also identifies and configures the local AI model 226 associated with spectrum efficiency, in accordance with the model parameter(s). The local AI model 226 is executed to generate locally inferred control parameter(s) for the control modules at the system node 120 (which may be used in place of or in addition to the globally inferred control parameter(s)). For example, control parameter(s) that may be inferred to satisfy the high throughput task may include parameters for a multi-TRP handover scheme, an interference control scheme for model interference control, a carrier aggregation and dual connectivity multi-carrier scheme, the RLC layer may be configured with a fast ARQ configuration, the MAC layer may be configured to use an aggressive resource scheduling and power control for uplink communications, and the PHY layer may be configured to use an antenna configuration for massive MIMO. The AI execution module 220 collects local network data (e.g., actual throughput rate) and communicates the local data (which may include both the collected local network data and the local model data, such as the locally trained weights of the local AI model 226) to the AI management module 210. The AI management module 210 updates the global AI database 218 and performs non-RT training of the global AI model 216, to generate updated inference data. These operations may be repeated to continue satisfying the task request (i.e., enabling high throughput).

FIG. 5B is a flowchart illustrating an example method 500 for AI-based configuration, that may be performed using the AI execution module 220. For simplicity, the method 500 will be discussed in the context of the AI execution module 220 implemented at a system node 120. However, it should be understood that the method 500 may be performed using the AI execution module 220 implemented at a UE 110. For example, the method 500 may be performed using the computing system 250 of FIG. 2B (which may be a UE 110 or a BS, for example), by the processing unit 251 executing instructions stored in the memory 258.

Optionally, at 502, a task request is sent to the AI management module 210, which is implemented at a network node 131. The task request may be a request for a particular network task, including a request for a service, a request to meet a network requirement, or a request to set a control configuration, for example. The task request may be a request for a collaborative task, such as collaborative training of an AI model. The collaborative task request may include an identifier of the AI model to be collaboratively trained, initial or locally trained parameters of the AI model, one or more training targets or requirements, and/or a set of training data (or an identifier of the training data) to be used for collaborative training.

At 504, a first set of configuration information is received from the AI management module 210. The received configuration information may be referred to herein as a first set of configuration information. The first set of configuration information may be received in the form of a configuration message. The configuration message may be transmitted over an AI-dedicated logical layer, such as the AIEMP layer in the A-plane as described above. The first set of configuration information may include one or more control parameters and/or one or more model parameters. The first set of configuration information may include inference data generated by one or more trained global AI models at the AI management module 210.

At 506, the system node 120 configures itself in accordance with the control parameter(s) included in the first set of configuration information. For example, the AICF 224 at the AI execution module 220 of the system node 120 may perform operations to translate control parameter(s) in the first set of configuration information into a format that is useable by the control modules at the system node 120. Configuration of the system node 120 may include configuring the system node 120 to collect local network data relevant to the network task, for example.

At 508, the system node 120 configures one or more local AI models in accordance with the model parameter(s) included in the first set of configuration information. For example, the model parameter(s) included in the first set of configuration information may include an identifier (e.g., a unique model identification number) identifying which local AI model(s) should be used at the AI execution module 220 (e.g., the AI management module 210 may configure the AI execution module 220 to local AI model(s) that are the same as the global AI model(s), for example by transmitting the identifier(s) of the global AI model(s)). The AI execution module 220 may then initialize the identified local AI model(s) using weights included in the model parameter(s). In some examples, such as when the system node 120 has requested a collaborative task for collaborative training of the local AI model(s), the model parameter(s) included in the first set of configuration information may be the collaboratively trained parameter(s) (e.g., weights) of the local AI model(s). The AI execution module 220 may then update the parameter(s) of the local AI model(s) according to the collaboratively trained parameter(s).

At 510, the local AI model(s) are executed, to generate one or more locally inferred control parameters. The locally inferred control parameter(s) may replace or be in addition to any control parameter(s) included in the first set of configuration information. In other examples, there may not be any control parameter(s) included in the first set of configuration information (e.g., the configuration information from the AI management module 210 includes only model parameter(s)).

At 512, the system node 120 is configured in accordance with the locally inferred control parameter(s). For example, the AICF 224 at the AI execution module 220 of the system node 120 may perform operations to translate inferred control parameter(s) generated by the local AI model(s) into a format that is useable by the control modules at the system node 120. It should be noted that the locally inferred control parameter(s) may be used in addition to any control parameter(s) included in the first set of configuration information. In other examples, there may not be any control parameter(s) included in the first set of configuration information.

Optionally, at 514, a second set of configuration information may be transmitted to one or more UEs 110 associated with the system node 120. The transmitted configuration information may be referred to herein as a second set of configuration information. The second set of configuration information may be transmitted in the form of a downlink configuration (e.g., as a DCI or RRC signal). The second set of configuration information may be transmitted over an AI-dedicated logical layer, such as the AIP layer in the A-plane as described above. The second set of configuration information may include control parameter(s) from the first set of configuration information. The second set of configuration information may additionally or alternatively include locally inferred control parameter(s) generated by the local AI model(s). The second set of configuration information may also configure the UE(s) 110 to collect local network data relevant to training the local AI model(s) (e.g., depending on the task). Step 514 may be omitted if the method 500 is performed by a UE 110 itself. Step 514 may also be omitted if there are no control parameter(s) applicable to the UE(s) 110. Optionally, the second set of configuration information may also include one or more model parameters for configuring local AI model(s) by an AI execution module 220 at the UE(s) 110.

At 516, local data is collected. Collected local data may include network data collected at the system node 120 itself and/or network data collected from one or more UEs 110 associated with the system node 120. The collected local network data may be preprocessed using functions provided by the AICF 224, for example, and may be maintained in a local AI database.

Optionally, at 518, the local AI model(s) may be trained using the collected local network data. The training may be performed in near-RT (e.g., within several microseconds or several milliseconds of the local network data being collected), to enable the local AI model(s) to be updated to reflect the dynamic local environment. The near-RT training may be relatively fast (e.g., involving only up to five or up to ten training iterations). Optionally, after training the local AI model(s) using the collected local network data, the method 500 may return to step 510 to execute the updated local AI model(s) to generate updated locally inferred control parameter(s). The trained model parameters (e.g., trained weights) of the updated local AI model(s) may be extracted by the AI execution module 220 and stored as local model data.

At 520, the local data is transmitted to the AI management module 210. The transmitted local data may include the local network data collected at step 516 and/or may include local model data (e.g., if optional step 518 is performed). For example, local data may be transmitted (e.g., using output functions provided by the AICF 224) over an AI-dedicated logical layer, such as the AIEMP layer in the A-plane as described above. The AI management module 210 may collect local data from one or more RANs 120 and/or UEs 110 to update the global AI model(s), and to generate updated configuration information. The method 500 may return to step 504 to receive the updated configuration information from the AU management module 210.

Steps 504 to 520 may be repeated one or more times, to continue satisfying a task request (e.g., continue providing a requested network service, or continue collaborative training of an AI model). Further, within each iteration of steps 504 to 520, steps 510 to 518 may optionally be repeated one or more times. For example, in one iteration of steps 504 to 520, step 520 may be performed once, to provide the local data to the AI management module 210 in a non-RT data transmission (e.g., the local data may be transmitted to the AI management module 210 more than several milliseconds after the local data was collected). For example, the AI execution module 220 may periodically (e.g., every 100 ms or every 1s) or intermittently transmit local data to the AI management module 210. However, between the time that the local network data was collected (at step 516) and the time that the local data is transmitted to the AI management module 210 (at step 520), the local AI model(s) may be repeatedly trained in near-RT on the collected local network data and the configuration of the system node 120 may be repeatedly updated using the locally inferred control parameter(s) from the updated local AI model(s). Further, between the time that the local data is transmitted to the AI management module 210 (at step 520) and the time that updated configuration information (generated by the updated global AI model(s)) is received from the AI management module (at step 504), the local AI model(s) may continue to be retrained in near-RT using the collected local network data.

FIG. 5C is a flowchart illustrating an example method 550 for AI-based configuration, that may be performed using the AI management module 210 implemented at the network node 131. The method 550 involves communications with one or more AI execution modules 220, which may include AI execution module(s) 220 implemented at a system node 120 and/or at a UE 110. The method 550 may be performed using the computing system 250 of FIG. 2B (which may be a network server, for example), by the processing unit 251 executing instructions stored in the memory 258.

At 552, a task request is received. For example, the task request may be received from a system node 120 that is managed by the AI management module 210, may be received from a customer of the wireless system 100, or may be received from an operator of the wireless system 100. The task request may be a request for a particular network task, including a request for a service, a request to meet a network requirement, or a request to set a control configuration, for example. In another example, the task request may be a request for a collaborative task, such as collaborative training of an AI model. The collaborative task request may include an identifier of the AI model to be collaboratively trained, initial or locally trained parameters of the AI model, one or more training targets or requirements, and/or a set of training data (or an identifier of the training data) to be used for collaborative training.

At 554, the network node 131 is configured in accordance with the task request. For example, the AI management module 210 may (e.g., using output functions of the AICF 214) convert the task request into one or more configurations to be implemented at the network node 131. For example, the network node 131 may be configured to set one or more performance requirements in accordance with the network task (e.g., set a maximum end-to-end delay in accordance with a URLLC task).

At 556, one or more global AI models are selected in accordance with the task request. A single network task may require multiple functions to be performed (e.g., to satisfy multiple task requirements). For example, a single network task may involve multiple KPIs to be satisfied (e.g., a URLLC task may involve satisfying latency requirements as well as interference requirements). The AI management module 210 may select, from a plurality of available global AI models, one or more selected global AI models to address the network task. For example, the AI management module 210 may select one or more global AI models based on the associated task defined for each global AI model. In some examples, the global AI model(s) that should be used for a given network task may be predefined (e.g., the AI management module 210 may use a predefined rule or lookup table to select the global AI model(s) for a given network task). In another example, the global AI model(s) may be selected in accordance with an identifier (e.g., included in a request for a collaborative task) included in the task request.

At 558, the selected global AI model(s) are trained using global data (e.g., from a global AI database maintained by the AI management module 210). Training of the selected global AI model(s) may be more comprehensive than the near-RT training of local AI model(s) performed by the AI execution module 220. For example, the selected global AI model(s) may be trained for a larger number of training iterations (e.g., more than 10 or up to 100 or more training iterations), compared to the near-RT training of local AI model(s). The selected global AI model(s) may be trained until a convergence condition is satisfied (e.g., the loss function for each global AI model converge at a minimum). The global data includes network data collected from one or more AI execution modules (e.g., at one or more system nodes 120 and/or one or more UEs 110) managed by the AI management module 210, and is non-RT data (i.e., the global data does not reflect the actual network environment in real-time). The global data may also include training data provided or identifier for collaborative training (e.g., included in a collaborative task request).

At 560, after training is complete, the selected global AI model(s) are executed to generate globally inferred control parameter(s). If multiple global AI models have been selected, each global AI model may generate a subset of the globally inferred control parameter(s). In some examples, if the task is a collaborative task for collaborative training of an AI model, step 560 may be omitted.

At 562, configuration information is transmitted to the one or more AI execution modules 220 managed by the AI management module 210. The configuration information includes the globally inferred control parameter(s), and/or may include global model parameter(s) extracted from the selected global AI model(s). For example, the trained weights of the selected global AI model(s) may be extracted and included in the transmitted configuration information. The configuration information transmitted by the AI management module 210 to one or more AI execution modules 220 may be referred to as the first set of configuration information. The first set of configuration information may be transmitted in the form of a configuration message. The configuration message may be transmitted over an AI-dedicated logical layer, such as the AIEMP layer in the A-plane (e.g., if the AI execution module(s) 220 are at respective system node(s) 120) and/or the AIP layer in the A-plane (e.g., if the AI execution module(s) 220 are at respective UE(s) 110) as described above.

At 564, local data is received from respective AI execution module(s) 220. The local data may include local network data collected by each respective AI execution module(s) and/or may include local model data (e.g., locally trained weights of the respective local AI model(s)) extracted by each respective AI execution module(s) after near-RT training of the local AI model(s). The local data may be received over an AI-dedicated logical layer, such as the AIEMP layer in the A-plane (e.g., if the AI execution module(s) 220 are at respective system node(s) 120) and/or the AIP layer in the A-plane (e.g., if the AI execution module(s) 220 are at respective UE(s) 110) as described above. It should be understood that there may be some time interval between step 562 and 564 (e.g., a time interval of several milliseconds, up to 100 ms, or up to 1s), during which local data collection and optional local training of local AI model(s) may take place at the respective AI execution module(s) 220.

At 566, the global data (e.g., stored in the global AI database maintained by the AI management module 210) is updated with the received local data. The method 550 may return to step 558 to retrain the selected global AI model(s) using the updated global data. For example, if the received local data include locally trained weights extracted from local AI model(s), retraining the selected global AI model(s) may include updating the weights of the global AI model(s) based on the locally trained weights.

Steps 558 to 566 may be repeated one or more times, to continue satisfying a task request (e.g., continue providing a requested network service, or continue collaborative training of an AI model).

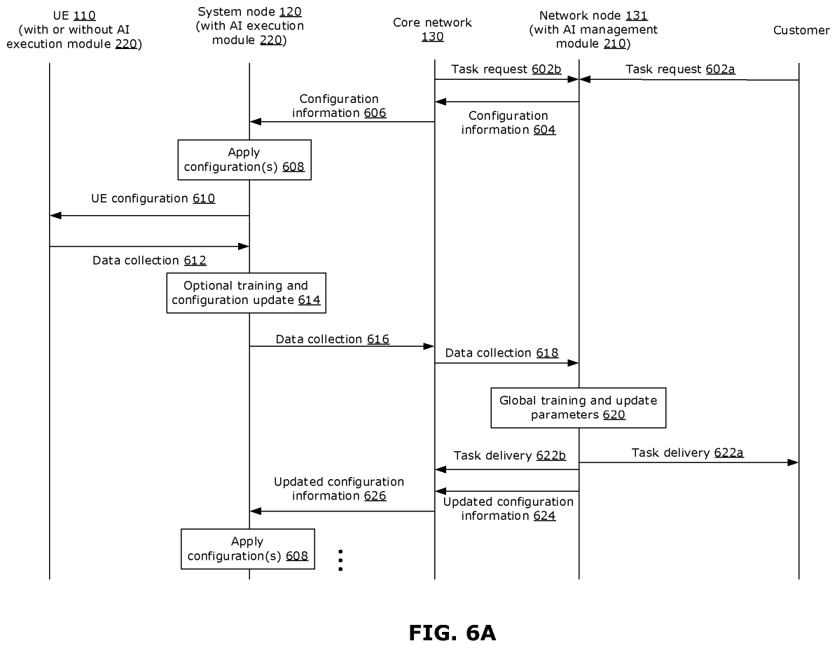

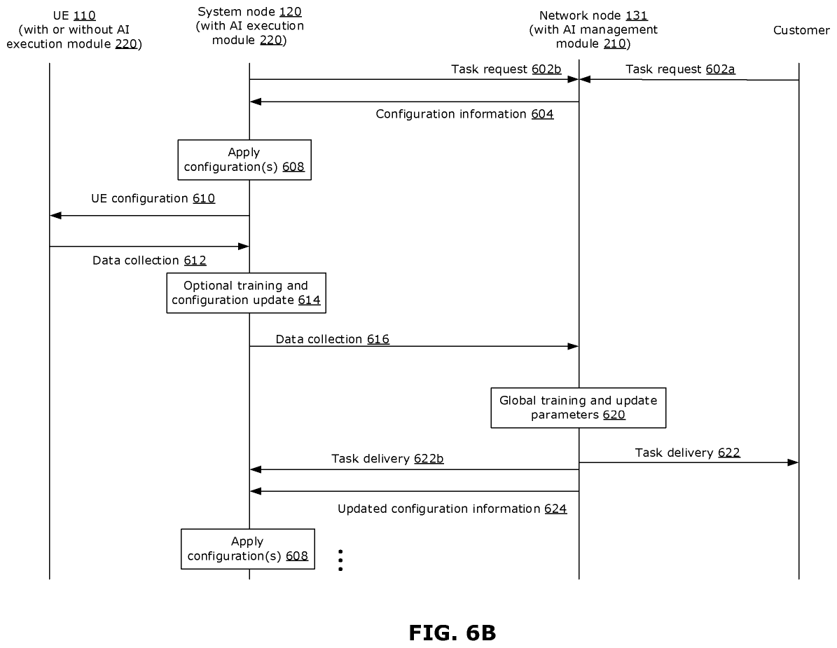

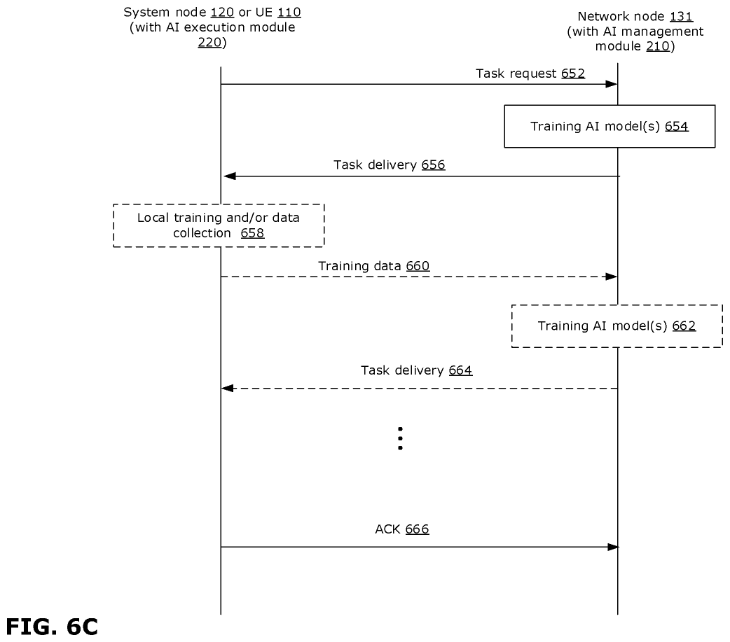

FIG. 6A is a signaling diagram illustrating an example of signals that may be communicated for AI-based configuration, for example in accordance with the methods 500 and 550. In this example, signaling is shown between a customer of the wireless system 100, the network node 131 (where the AI management module 210 is implemented), the core network 130, the system node 120 (where the AI execution module 220 is implemented), and the UE 110 (where the AI execution module 220 may or may not be implemented). In this example, communications between the network node 131 and the system node 120 may be relayed via the core network 130 (e.g., using AMF), for example as shown in the example of FIG. 1A. It should be noted that the network node 131 may communicate with the system node 120 via the core network 130 regardless of whether the network node 131 is within the core network 130, or outside the core network 130.

The signaling may begin with a task request at 602a from the core network 130 (e.g., a task request from the system node 120 may be relayed by the core network 130, or a task request may be generated by the core network 130 itself) or a task request at 602b from outside the core network 130 (e.g., from a customer of the wireless system 100). The network node 131 may receive different task requests from the core network 130 and from the customer, for example. The task request may be a network task request and may indicate a service to be provided, a task requirement, and may include one or more KPIs and/or traffic types, as discussed previously. The task request may be a collaborative task request and may indicate one or more AI models to be collaboratively trained, for example. The task request may also indicate one or more training targets and/or requirements for collaborative training. The task request may also include an identifier of training data to be used and/or may include training data to be used for collaborative training. The task request may also include model data (e.g., locally trained model parameters) to be updated by collaborative training. For example, collaborative training may be performed by the network node 131 training an AI model on behalf of one or more system nodes 120 and/or UEs 110. Collaborative training may also be performed by the network node 131 using locally trained model parameters to update a global AI model (e.g., a form of federated learning). Other such collaborative tasks are possible within the scope of the present disclosure.

The network node 131 generates inferred control parameter(s) and/or model parameter(s) using one or more global AI model(s), as discussed previously, and transmits configuration information, at 604 and 606, to the system node 120 via the core network 130. The configuration information may include identification of one or more local AI models to be used at the system node 120, and one or more model parameters (e.g., weights) to configure the local AI model(s). For example, if the task is a collaborative task, the configuration information may include model parameters that were trained at the network node 131, and that are used by the system node 120 to update the local AI model(s). The configuration information may also configure the system node 120 to collect local network data for the task (e.g., to monitor KPI(s) and task requirements associated with a requested network task).

At 608, the system node 120 applies the configuration information, to configure its own control modules and/or to implement one or more local AI models. For example, the system node 120 may configure one or more RLC, MAC, PHY and/or radio (e.g., antenna and beamforming) functions in accordance with control parameter(s) in the configuration information. The system node 120 may also configure itself to enable collection of local network data, in accordance with the configuration information. The system node 120 may also use model parameter(s) in the configuration information to select, configure and execute local AI model(s) to generate locally inferred control parameter(s). The system node 120 transmits, at 610, configuration information to the UE 110. For example, the system node 120 may transmit inferred control parameter(s) to be implemented by the UE 110 (e.g., similar to configurations implemented at the system node 120). The system node 120 may also configure the UE 110 to enable collection of local network data. If the UE 110 itself implements an AI execution module 220, the system node 120 may also transmit model parameter(s) to enable the UE 110 to identify, configure and execute one or more local AI models (e.g., similar to local AI model(s) implemented at the system node 120).

Local network data collected by the UE 110 is transmitted, at 612, to the system node 120. Optionally, if the UE 110 itself implements one or more local AI models, the local AI model(s) may be updated by the UE 110 and model data (e.g., updated model weights) may also be transmitted at 612. At 614, the system node 120 may execute the local AI model(s) using locally collected network data collected (including local network data collected from the UE 110, as well as local network data collected by the system node 120 itself). The system node 120 may optionally train its local AI model(s) using the locally collected network data. The system node 120 may update its configuration based on locally inferred control parameter(s) generated by the local AI model(s).

The system node 120 transmits, at 616 and 618, local data (including raw local data such as raw local network data and/or processed local data such as local model data) to the network node 131 via the core network 130. At 620, the network node 131 performs non-RT training of the global AI model(s), using the local data. If necessary (e.g., if the updated global AI model(s) generate inferred data that is different from previously inferred data, or if the updated global AI model(s) have updated weights that should be updated at the local AI model(s)) the network node 131 may update the globally inferred control parameter(s) and/or model parameter(s). At 622a, if the task request was sent from the customer at 602a, the network node 131 delivers the requested task to the customer (e.g., result or report of the requested service, or model parameters for a collaboratively trained AI model). At 622b, if the task request was sent from the core network 130, the network node 131 delivers the requested task to the core network 130 (e.g., result or report of the requested service, or model parameters for a collaboratively trained AI model). If the task request originated from the system node 120, the core network 130 may further relay the result or report to the system node 120. If necessary, the network node 131 may transmit, at 624 and 626, updated configuration information to the system node 120 (e.g., to update configuration of control modules, to update configuration of local AI model(s), etc.). The updated configuration information may be transmitted in an update message that includes only the updated configuration information, or may be transmitted in a configuration message that includes updated configuration information as well as unchanged configuration information. The system node 120 may then apply the configuration information at 608, and the procedure may repeat through the steps and signaling described above.

FIG. 6B is a signaling diagram illustrating another example of signals that may be communicated, for example to perform the methods 500 and 550. In this example, signaling is shown between a customer of the wireless system 100, the network node 131 (where the AI management module 210 is implemented), the system node 120 (where the AI execution module 220 is implemented), and the UE 110 (where the AI execution module 220 may or may not be implemented). Compared to the example of FIG. 6A, in this example the network node 131 may communicate directly with the system node 120 (rather than via the AMF of the core network 130), for example as shown in the example of FIGS. 1B and 1C. It should be noted that the network node 131 may communicate directly with the system node 120 regardless of whether the network node 131 is within the core network 130, or outside the core network 130.

The procedure of FIG. 6B is similar to that of FIG. 6A, and does not need to be repeated in detail here. Compared to the example of FIG. 6A, the signals 604, 616 and 624 are communicated directly between the network node 131 and the system node 120, rather than via the core network 130.

FIG. 6C is a signaling diagram illustrating another example of signals that may be communicated, for example to perform the methods 500 and 550. In this example, signaling is shown between the network node 131 (where the AI management module 210 is implemented) and the system node 120 or UE 110 (where the AI execution module 220 can be implemented). In this example the signaling may be communicated between the network node 131 and the system node 120 or UE 110 for a task request related to training an AI model by the network node 131. Although the core network 130 is not shown in FIG. 6C, it should be understood that in some examples communications between the network node 131 and the system node 120 or UE 110 may be relayed via the AMF of the core network 130 (e.g., similar to the role of the core network 130 in FIG. 6A). It should be noted that the network node 131 may communicate directly with the system node 120 regardless of whether the network node 131 is within the core network 130, or outside the core network 130. Further, communications between the network node 131 and the UE 110 may be relayed via the system node 120 (e.g., a BS serving the UE 110) or the network node 131 may directly communicate with the UE 110 (e.g., the network node 131 may be a node that is located close to the UE 110, such as a node in the AN serving the UE 110). It should be noted that the network node 131 may be a node of the core network 130, or outside of the core network 130. Further, the network node 131 may be a standalone AI device or node that provides AI training and modeling functions (e.g., functioning as an AI toolbox accessible by any node in the wireless system 100).

The signaling may begin with a task request at 652 from a requestor. The requestor may be a system node 120 or a UE 110, for example. The task request message 652 may be transmitted via a wireline or wireless communication interface, for example using an interface protocol over the control/data plane or the A-plane 410 as described above. The task request message 652 may include a set of training data (or an identifier of a set of training data), one or more optimization targets or requirements, and/or one or more identified target AI models to be trained.

It should be noted that the training data may be raw data (e.g., unprocessed or minimally processed data generated or collected by regular operation of the system node 120 or UE 110, such as photographs, videos, location data, etc.) or processed data (e.g., AI-related data, such as inferred data generated by an AI model or model parameters of the target AI model(s) to be trained). The optimization target(s) or requirement(s) may include characteristic descriptions of the optimization to be performed by the network node 131, for example, to minimize a defined cost function, maximize one or more KPIs, or maximize one or more parameters (such as distance), among other possibilities. The target AI model(s) may be (after training is complete) used to generate inferred data that may apply to control of various wireless functionalities (which may be controlled by configuration of control and signal components in the wireless system 100), such as MIMO, beamforming, channel encoding, waveform signal designs, power control, resource allocations, mobility modeling, channel rebuilding, spectrum utilization including carrier/band width part assignment, and/or TRP selection among others.

The task request message 652 may include a set of input-related attributes associated with a given target AI model and a set of output-related attributes associated with the given target AI model. For example, the set of input-related attributes associated with a given target AI model may include an identifier of the given target AI model, and/or any of the previously mentioned input-related attributes (e.g., what type(s) of raw data and/or AI-related data may be accepted as input data; one or more APIs for interacting with other software modules (e.g., to receive input data); which system node(s) 120 and/or UE(s) 110 can participate in providing input data to the AI model; and/or one or more data transfer protocols to be used for communicating input data; among others). The output-related attributes associated with the given target AI model may include any of the previously mentioned output-related attributes (e.g., the target of the inference output; and/or control parameter(s) that are the target of the inference output; among others).

Although in this example training data to be used (or an indicator of the training data to be used) for training the target AI model(s) is included in the task request at 652, in other examples the training data (or indicator of the training data) may be transmitted in a separate communication to the network node 131. Further, as will be discussed below, additional training data may be provided later in the training phase.

In some examples, the task request may not include an identifier of the target AI model(s) to be trained. Instead, the task request may include a model definition, including a definition of the associated task, the input-related attributes and/or output-related attributes of the target AI model(s). This definition may be used by the network node 131 to select target AI model(s) to be trained (e.g., from a plurality of global AI model(s) available to the AI management module 210 at the network node 131).

After receiving the task request, the network node 131 at 654 uses the functions of the AI management module 210 to perform training of the target AI model(s) in accordance with information included in the task request (e.g., in accordance with the training data, the optimization target(s) or requirements and/or identified AI model(s)). If the task request included an identifier of the target AI model(s), the network node 131 may select the identified AI model(s) and perform training (e.g., using training data indicated or provided with the task request or in a subsequent communication; and/or using global data stored in a global AI database managed by the AI management module 210). If the task request did not include an identifier of the target AI model(s), the network node 131 may select the target AI model(s) to be trained in accordance with the model definition included in the task request. Alternatively, if the network node 131 does not have access to any AI models that fit the model definition in the task request, the network node 131 may generate a new AI model (e.g., by requesting design of a new AI model from a third-party, or by starting with a generic AI architecture such as a generic CNN or a generic DNN). The training at 654 may be performed until a convergence condition is met (e.g., the optimization target(s) or requirement(s) included in the task request is met; until a defined loss function converges; or until a defined number of training iterations have been completed; among other possibilities).

After the training is complete, the network node 131 transmits a task delivery message at 656 to the requestor (e.g., the system node 120 or UE 110). The task delivery message may include trained model parameters for the target AI model(s). If the target AI model(s) was not identified in the task request, the task delivery message may also include and identifier of the target AI model(s). If the target AI model(s) was newly generated, the task delivery message may also include configuration information for the new target AI model(s) (e.g., information about the number of layers, dimensions, activation functions, etc. used in the newly generated AI model(s)) and/or software instructions encoding the new target AI model(s).

Optionally, at 658, the requestor (e.g., the system node 120 or UE 110) may perform collection of local training data (e.g., collection of local raw data) and/or may perform local training of the target AI model(s) (e.g., near-RT training of the target AI model(s) using the collected local raw data). In some embodiments, the optional collection of local data may include the system node 120 or UE 110 cooperating with other nodes (e.g., the system node 120 may cooperate with one or more UEs 110 associated with the system node 120; or the UE 110 may cooperate with one or more other UEs 110) to collect local data. The optional local training performed by the system node 120 or UE 110, using functions of the AI execution module 220, may be less comprehensive (e.g., having fewer training iterations) than the training performed by the network node 131 using functions of the AI management module 210.

Optionally, additional training data may be transmitted to the network node 131 at 660. The additional training data may include any additional local data (e.g., local network from optional collection of local raw data and/or local model data from optional local training of the target AI model(s)). For example, the additional training data may include locally trained model parameter(s) (e.g., weights) of the target AI model(s). The additional training data may also include network data resulting from execution of the target AI model(s) by the system node 120 or UE 110. For example, the target AI model(s) may be executed using globally model parameters delivered by the network node 131, and the system node 120 or UE 110 may collect network data to measure the performance of the target AI model(s), which measurements may be used by the network node 131 to further optimize the target AI model(s). Other such variations may be possible.

After receiving the additional training data, the network node 131 at 662 optionally performs additional training of the target AI model(s). For example, if the additional training data included locally trained model parameters, the network node 131 may further update the locally trained model parameters by performing more comprehensive training. Additional training of the target AI model(s) may or may not result in new model parameters (e.g., the model weights remain at the same values). In some examples, the training data may indicate that one or more other AI model(s) should be selected as target AI model(s). For example, if the training data includes measurements indicating that the desired performance was not achieved by the current target AI model(s), the network node 131 may use functions of the AI management module 210 to select one or more other AI models (e.g., from a plurality of available global AI models, in accordance with a model definition included in the original task request) to add to the current target AI model(s) or replace one or more current target AI models.

Optionally, the network node 131, after completing the additional training, transmits an additional task delivery message to the requestor (e.g., the system node 120 or UE 110) at 664. If there is no updated information (e.g., no new model parameters and no new target AI model(s) result from the additional training), the task delivery message may be a simple notification that there is no update. If there is updated information (e.g., model parameters have been updated and/or new target AI model(s) have been identifier), the task delivery message includes the updated information. Alternatively, the task delivery message may include a notification that there is updated information, and the updated information may be transmitted to the system node 120 or UE 110 in a separate communication.

The optional signaling from 658 to 664 may be repeated to continue updating the target AI model(s). For example, 658 to 664 may be repeated until an acknowledgement (ACK) message from the requestor (e.g., system node 120 or UE 110) is transmitted to the network node 131 at 666. Alternatively, 658 to 664 may be repeated until an end point defined in the original task request (at 652). For example, the task request may define a time expiry or a maximum number of updates to be performed.

After the requested task is complete (e.g., due to an ACK from the requestor, or due to a defined end point being reached), the requestor (e.g., system node 120 or UE 110) may store the target AI model(s) locally (e.g., as local AI model(s)) and use the target AI model(s) to, for example, provide control and management for wireless functionalities. The network node 131 may store the target AI model(s) (e.g., as global AI model(s)) or may discard the target AI model(s). The target AI model(s) may be later trained again in a collaborative task.

The present disclosure has described some examples of AI-related communication, that may enable two or more nodes to cooperate in order to perform a task, such as a network task or a collaborative task. Two or more nodes may cooperate to implement AI model(s) for controlling wireless communication functionality, as an example of a network task. Two or more nodes may cooperate to collaboratively train an AI model, as an example of a requested task.

In the present disclosure, examples have been described that support communication of AI-related data between the UE 110, system node 120 and network node 131. It should be understood that communication of AI-related data may be over a wireless interface and/or over a wireline interface. Examples in which communications are described as taking place over a wireless interface are not intended to be limiting.

In the present disclosure, examples have been described in the context of the AI management module 210 being implemented at the network node 131, and the AI execution module 220 being implemented at the system node 120 and/or UE 110. More generally, it should be understood that functions of the AI management module 210 may be implemented at any AI-capable node in the wireless system 100 (including any node that is or is not part of the core network 130, or that is or is not managed by the core network 130), which may be referred to as the AI management node or simply the management node. Similarly, it should be understood that functions of the AI execution module 220 may be implemented at any AI-capable node in the wireless system 100, which may be referred to as the AI execution node or simply the execution node. Further, functions of the AI management module 210 may be implemented in any AI-capable node, which may be generally referred to as a first node (e.g., the network node 131 may be an example of the first node that provides functions of the AI management module 210, but this is not intended to be limiting); and functions of the AI execution module 220 may be implemented in any AI-capable node, which may be generally referred to as a second node (e.g., the system node 120 or the UE 110 may be an example of the second node that provides functions of the AI execution module 220, but this is not intended to be limiting).

A person of ordinary skill in the art may be aware that, in combination with the examples described in the embodiments disclosed in this disclosure, units and algorithm steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this disclosure.

It may be clearly understood by a person skilled in the art that, for the purpose of convenient and brief description, for a detailed working process of the foregoing system, apparatus, and unit, refer to a corresponding process in the foregoing method embodiments, and details are not described herein again.

It should be understood that the disclosed systems and methods may be implemented in other manners. The units described as separate parts may or may not be physically separate, and parts displayed as units may or may not be physical units, may be located in one position, or may be distributed on a plurality of network units. Some or all of the units may be selected according to actual requirements to achieve the objectives of the solutions of the embodiments. In addition, functional units in the embodiments of this application may be integrated into one processing unit, or each of the units may exist alone physically, or two or more units are integrated into one unit.

When the functions are implemented in the form of a software functional unit and sold or used as an independent product, the functions may be stored in a computer-readable storage medium. Based on such an understanding, the technical solutions of this disclosure essentially, or the part contributing to the prior art, or some of the technical solutions may be implemented in a form of a software product. The software product is stored in a storage medium, and includes several instructions for instructing a computer device (which may be a personal computer, a server, or a network device) to perform all or some of the steps of the methods described in the embodiments of this application. The foregoing storage medium includes any medium that can store program code, such as a universal serial bus (USB) flash drive, a removable hard disk, a read-only memory (ROM), a random access memory (RAM), a magnetic disk, or an optical disc, among others.

The foregoing descriptions are merely specific implementations of this application, but are not intended to limit the protection scope of this disclosure. Any variation or replacement readily figured out by a person skilled in the art within the technical scope disclosed in this disclosure shall fall within the protection scope of this disclosure.

1. A system for wireless communications comprising:
a communication interface configured for communications with a first node;
a processing unit coupled to the communication interface, the processing unit being configured to execute instructions to cause the system to:
transmit, to the first node, a task request, the task request requiring configuration of at least one of a wireless communication functionality of the system or a local artificial intelligence (AI) model; and
receive, from the first node, a first set of configuration information including a set of model parameters for the local AI model, the local AI model being configured by the set of model parameters to generate inference data including at least one inferred control parameter for configuring the system for wireless communication.

2. The system of claim 1, wherein the instructions cause the system to:
execute the local AI model using the set of model parameters, to generate the at least one inferred control parameter; and
configure at least one wireless communication functionality of the system in accordance with the at least one inferred control parameter.

3. The system of claim 1, wherein the instructions cause the system to:
collect local data, including at least one of: local network data useable for training the local AI model; or locally trained model parameters of the local AI model; and
transmit, to the first node, the collected local data.

4. The system of claim 3, wherein the instructions cause the system to:
perform near-real-time training of the local AI model using the local network data to obtain an updated local AI model; and
execute the updated local AI model, to generate at least one updated control parameter to configure the system.

5. The system of claim 1, wherein communications with the first node are received and transmitted over an AI-related logical layer in a protocol stack implemented by the system.

6. The system of claim 5, wherein the AI-related logical layer is a higher layer in the protocol stack above a radio resource control (RRC) layer, the AI-related logical layer being part of an AI-related control plane.

7. The system of claim 6, wherein the AI-related logical layer is a highest layer in the protocol stack above a non-access stratum (NAS) layer.

8. The system of claim 1, wherein the system is a second node that is a node in an access network serving a user equipment (UE), and wherein the instructions cause the system to:
transmit, to the UE, a second set of configuration information including at least the at least one inferred control parameter.

9. The system of claim 8, wherein the second set of configuration information further configures the UE to collect network data local to the UE, and wherein the instructions cause the system to:
receive, from the UE, collected network data local to the UE.

10. The system of claim 1, wherein the set of model parameters in the first set of configuration information includes model parameters from a global AI model at the first node.

11. A system for wireless communications comprising:
a communication interface configured for communications with a second node;
a processing unit coupled to the communication interface, the processing unit being configured to execute instructions to cause the system to:
receive a task request requiring configuration of at least one of a wireless communication functionality or a local artificial intelligence (AI) model of the second node; and
transmit, to the second node, a first set of configuration information including a set of model parameters for configuring the local AI model at the second node to generate at least one inferred control parameter for the second node, the set of model parameters being based on a configuration of at least one selected global AI model at the system, the at least one selected global AI model being selected, from a plurality of global AI models, in accordance with the task request.

12. The system of claim 11, wherein the instructions cause the system to:
execute the at least one selected global AI model, to generate at least one globally inferred control parameter for configuring the second node; and
wherein the first set of configuration information includes the at least one globally inferred control parameter.

13. The system of claim 11, wherein the instructions cause the system to:
receive, from the second node, data collected locally by the second node including at least one of: local network data useable for training the global AI model; or locally trained model parameters of the local AI model;
perform training of the at least one selected global AI model using the received data to obtain at least one updated global AI model; and
transmit, to the second node, updated configuration information based on a configuration of the at least one updated global AI model.

14. The system of claim 11, wherein communications with the second node are received and transmitted over an AI-related logical layer in a protocol stack implemented by the system.

15. The system of claim 14, wherein the AI-related logical layer is a higher layer in the protocol stack above a radio resource control (RRC) layer, the AI-related logical layer being part of an AI-related control plane.

16. The system of claim 15, wherein the AI-related logical layer is a highest layer in the protocol stack above a non-access stratum (NAS) layer.

17. A method, at a first node configured for communications with a second node, comprising:
receiving a task request requiring configuration of at least one of a wireless communication functionality or a local artificial intelligence (AI) model of the second node; and
transmitting, to the second node, a first set of configuration information including a set of model parameters for configuring the local AI model at the second node to generate at least one inferred control parameter for the second node, the set of model parameters being based on a configuration of at least one selected global AI model at the first node, the at least one selected global AI model being selected, from a plurality of global AI models, in accordance with the task request.

18. The method of claim 17, further comprising:
executing the at least one selected global AI model, to generate at least one globally inferred control parameter for configuring the second node; and
wherein the first set of configuration information includes the at least one globally inferred control parameter.

19. The method of claim 17, further comprising:
receiving, from the second node, data collected locally by the second node including at least one of: local network data useable for training the global AI model; or locally trained model parameters of the local AI model;
performing training of the at least one selected global AI model using the received data to obtain at least one updated global AI model; and
transmitting, to the second node, updated configuration information based on a configuration of the at least one updated global AI model.

20. The method of claim 17, wherein communications with the second node are received and transmitted over an AI-related logical layer in a protocol stack implemented by the system, wherein the AI-related logical layer is a highest layer in the protocol stack above a radio resource control (RRC) layer and above a non-access stratum (NAS) layer, the AI-related logical layer being part of an AI-related control plane.
